(19) United States
(12) Patent Application Publication
(10) Pub. No.: US 2018/0322623 A1
(43) Pub. Date: Nov. 8, 2018

(54) SYSTEMS AND METHODS FOR INSPECTION AND DEFECT DETECTION USING 3-D SCANNING

(71) Applicant: AQUIFI, INC., Palo Alto, CA (US)

(72) Inventors: Alvise Memo, Marcon (VE) (IT); David Demirdjian, Boca Raton, FL (US); Giulio Marin, Sunnyvale, CA (US); Kinh Tieu, Sunnyvale, CA (US); Francesco Peruch, Sunnyvale, CA (US); Pietro Salvagnini, Sunnyvale, CA (US); Giridhar Murali, Sunnyvale, CA (US); Carlo Dal Mutto, Sunnyvale, CA (US); Guido Cesare, Santa Cruz, CA (US)

(21) Appl. No.: 15/974,595

(22) Filed: May 8, 2018

Related U.S. Application Data
(60) Provisional application No. 62/503,115, filed on May 8, 2017.

(51) Int. Cl. G06T 7/00; G06T 15/20; G06T 7/55; G06T 17/20; G06N 5/04; G06N 3/04; G06N 3/08

(52) U.S. Cl. CPC G06T 7/0004; G06T 15/205; G06T 7/55; G06T 2207/10028; G06N 5/046; G06N 3/0454; G06N 3/08; G06T 17/20

(57) ABSTRACT

A method for detecting defects in objects includes: controlling, by a processor, one or more depth cameras to capture a plurality of depth images of a target object; computing, by the processor, a three-dimensional (3-D) model of the target object using the depth images; rendering, by the processor, one or more views of the 3-D model; computing, by the processor, a descriptor by supplying the one or more views of the 3-D model to a convolutional stage of a convolutional neural network; supplying, by the processor, the descriptor to a defect detector to compute one or more defect classifications of the target object; and outputting the one or more defect classifications of the target object.

### CROSS-REFERENCE TO RELATED APPLICATION(S)

This application claims the benefit of U.S. Provisional Patent Application No. 62/503,115 filed in the United States Patent and Trademark Office on May 8, 2017, the entire disclosure of which is incorporated by reference herein.

### FIELD

Aspects of embodiments of the present invention relate to the field of computer vision, in particular, the inspection and detection of defects in objects. In some embodiments, objects are scanned using one or more range (or depth) cameras.

### BACKGROUND

Quality control in manufacturing typically involves inspecting manufactured products to detect defects. For example, a human inspector may visually inspect the objects to determine whether the object satisfies particular quality standards, and manually sort the object into accepted and rejected instances (e.g., directing the object to a particular location by touching the object or by controlling a machine to do so).

Automatic inspection of manufactured objects can automate inspection activities that might otherwise be manually performed by a human, and therefore can improve the quality control process by, for example, reducing or removing errors made by human inspectors, reducing the amount of time needed to inspect each object, and enabling the analysis of a larger number of produced objects (e.g., as opposed to sampling from the full set of the manufactured objects and inspecting only the manufactured subset).

### SUMMARY

Aspects of embodiments of the present invention are directed to systems and methods for inspecting objects and identifying defects in the objects by capturing information about the objects using one or more range and color cameras.

According to one embodiment of the present invention, a method for detecting defects in objects includes: controlling, by a processor, one or more depth cameras to capture a plurality of depth images of a target object; computing, by the processor, a three-dimensional (3-D) model of the target object using the depth images; rendering, by the processor, one or more views of the 3-D model; computing, by the processor, a descriptor by supplying the one or more views of the 3-D model to a convolutional stage of a convolutional neural network; supplying, by the processor, the descriptor to a defect detector to compute one or more defect classifications of the target object; and outputting the one or more defect classifications of the target object.

The method may further include controlling a conveyor system to direct the target object is accordance with the one or more defect classifications of the target object.

The method may further include displaying the one or more defect classifications of the target object on a display device.

The defect detector may include a fully connected stage of the convolutional neural network.

The convolutional neural network may be trained based on an inventory including: a plurality of 3-D models of a plurality of defective objects, each 3-D model of the defective objects having a corresponding defect classification; and a plurality of 3-D models of a plurality of non-defective objects.

Each of the defective objects and non-defective objects of the inventory may be associated with a corresponding descriptor, and the classifier may be configured to compute the classification of the target object by: outputting the classification associated with a corresponding descriptor of the corresponding descriptors having a closest distance to the descriptor of the target object.

The one or more views may include a plurality of views, and wherein the computing the descriptor may include: supplying each view of the plurality of views to the convolutional stage of the convolutional neural network to generate a plurality of single view descriptors; and supplying the plurality of single view descriptors to a max pooling stage to generate the descriptor from the maximum values of the single view descriptors.

The computing the descriptor may include: supplying the one or more views of the 3-D model to a feature detecting convolutional neural network to identify shapes of one or more features of the 3-D model.

The defect detector may be configured to compute at least one of the one or more defect classifications of the target object by: counting or measuring the shapes of the one or more features of the 3-D model to generate at least one count or at least one measurement; comparing the at least one count or at least one measurement to a tolerance threshold; and determining the at least one of the one or more defect classifications as being present in the target object in response to determining that the at least one count or at least one measurement is outside the tolerance threshold.

The 3-D model may include a 3-D mesh model computed from the depth images.

The rendering the one or more views of the 3-D model may include: rendering multiple views of the entire three-dimensional model from multiple different virtual camera poses relative to the three-dimensional model.

The rendering the one or more views of the 3-D model may include: rendering multiple views of a part of the three-dimensional model.

The rendering the one or more views of the 3-D model may include: dividing the 3-D model into a plurality of voxels; identifying a plurality of surface voxels of the 3-D model by identifying voxels that intersect with a surface of the 3-D model; computing a centroid of each surface voxel; and computing orthogonal renderings of the normal of the surface of the 3-D model in each of the surface voxels, and the one or more views of the 3-D model may include the orthogonal renderings.

Each of the one or more views of the 3-D model may include a depth channel.

According to one embodiment of the present invention, a system for detecting defects in objects includes: one or more depth cameras configured to capture a plurality of depth images of a target object; a processor configured to control the one or more depth cameras; a memory storing instructions that, when executed by the processor, cause the processor to: control the one or more depth cameras to capture the plurality of depth images of the target object; compute a three-dimensional (3-D) model of the target object using the depth images; render one or more views of the 3-D model; compute a descriptor by supplying the one or more views of the 3-D model to a convolutional stage of a convolutional neural network; supply the descriptor to a defect detector to compute one or more defect classifications of the target object; and output the one or more defect classifications of the target object.

The memory may further store instructions that, when executed by the processor, cause the processor to control a conveyor system to direct the target object is accordance with the one or more defect classifications of the target object.

The memory may further store instructions that, when executed by the processor, cause the processor to displaying the one or more defect classifications of the target object on a display device.

The defect detector may include a fully connected stage of the convolutional neural network.

The convolutional neural network may be trained based on an inventory including: a plurality of 3-D models of a plurality of defective objects, each 3-D model of the defective objects having a corresponding classification; and a plurality of 3-D models of a plurality of non-defective objects.

Each of the defective objects and non-defective objects of the inventory may be associated with a corresponding descriptor, and the classifier may be configured to compute the classification of the target object by: outputting the classification associated with a corresponding descriptor of the corresponding descriptors having a closest distance to the descriptor of the target object.

The one or more views may include a plurality of views, and the memory may further store instructions that, when executed by the processor, cause the processor to compute the descriptor by: supplying each view of the plurality of views to the convolutional stage of the convolutional neural network to generate a plurality of single view descriptors; and supplying the plurality of single view descriptors to a max pooling stage to generate the descriptor from the maximum values of the single view descriptors.

The memory may further store instructions that, when executed by the processor, cause the processor to compute the descriptor by: supplying the one or more views of the 3-D model to a feature detecting convolutional neural network to identify shapes of one or more features of the 3-D model.

The defect detector may be configured to compute at least one of the one or more defect classifications of the target object by: counting or measuring the shapes of the one or more features of the 3-D model to generate at least one count or at least one measurement; comparing the at least one count or at least one measurement to a tolerance threshold; and determining the at least one of the one or more defect classifications as being present in the target object in response to determining that the at least one count or at least one measurement is outside the tolerance threshold.

The 3-D model may include a 3-D mesh model computed from the depth images.

The memory may further store instructions that, when executed by the processor, cause the processor to render the one or more views of the 3-D model by: rendering multiple views of the entire three-dimensional model from multiple different virtual camera poses relative to the three-dimensional model.

The memory may further store instructions that, when executed by the processor, cause the processor to render the one or more views of the 3-D model by: rendering multiple views of a part of the three-dimensional model.

The memory may further store instructions that, when executed by the processor, cause the processor to render the one or more views of the 3-D model by: dividing the 3-D model into a plurality of voxels; identifying a plurality of surface voxels of the 3-D model by identifying voxels that intersect with a surface of the 3-D model; computing a centroid of each surface voxel; and computing orthogonal renderings of the normal of the surface of the 3-D model in each of the surface voxels, and wherein the one or more views of the 3-D model includes the orthogonal renderings.

Each of the one or more views of the 3-D model includes a depth channel.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

These and other features and advantages of embodiments of the present disclosure will become more apparent by reference to the following detailed description when considered in conjunction with the following drawings. In the drawings, like reference numerals are used throughout the figures to reference like features and components. The figures are not necessarily drawn to scale.

FIG. 1A is a schematic block diagram of a system for training a defect detection system and a system for detecting defects using the trained defect detection system according to one embodiment of the present invention.

FIGS. 1B, 1C, and 1D are schematic illustrations of the process of detecting defects in target objects according to some embodiments of the present invention.

FIG. 2A is a schematic depiction of an object (depicted as a handbag) traveling on a conveyor belt with a plurality of (five) cameras concurrently imaging the object according to one embodiment of the present invention.

FIG. 2B is a schematic depiction of an object (depicted as a handbag) traveling on a conveyor belt having two portions, where the first portion moves the object along a first direction and the second portion moves the object along a second direction that is orthogonal to the first direction in accordance with one embodiment of the present invention.

FIG. 2C is a block diagram of a stereo depth camera system according to one embodiment of the present invention.

FIG. 3 is a schematic block diagram illustrating a process for capturing images of a target object and detecting defects in the target object according to one embodiment of the present invention.

FIG. 4 is a flowchart of a method for detecting defects in a target object according to one embodiment of the present invention.

FIG. 5A is a flowchart of a method for rendering 2-D views of a target object according to one embodiment of the present invention.

FIG. 5B is a flowchart of a method for rendering 2-D views of patches of an object according to one embodiment of the present invention.

FIG. 5C is a schematic depiction of the surface voxels of a 3-D model of a handbag.

FIG. 6 is a flowchart illustrating a descriptor extraction stage 440 and a defect detection stage 460 according to one embodiment of the present invention.

FIG. 7 is a block diagram of a convolutional neural network according to one embodiment of the present invention.

FIG. 8 is a flowchart of a method for training a convolutional neural network according to one embodiment of the present invention.

FIG. 9 is a schematic diagram of a max-pooling neural network according to one embodiment of the present invention.

FIG. 10 is a flowchart of a method for generating descriptors of locations of features of a target object according to one embodiment of the present invention.

FIG. 11 is a flowchart of a method for detecting defects based on descriptors of locations of features of a target object according to one embodiment of the present invention.

### DETAILED DESCRIPTION

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

Aspects of embodiments of the present invention relate to capturing three-dimensional (3-D) or depth images of target objects using one or more three-dimensional (3-D) range (or depth) cameras and analyzing the 3-D images and detecting defects in the target objects by analyzing the captured images.

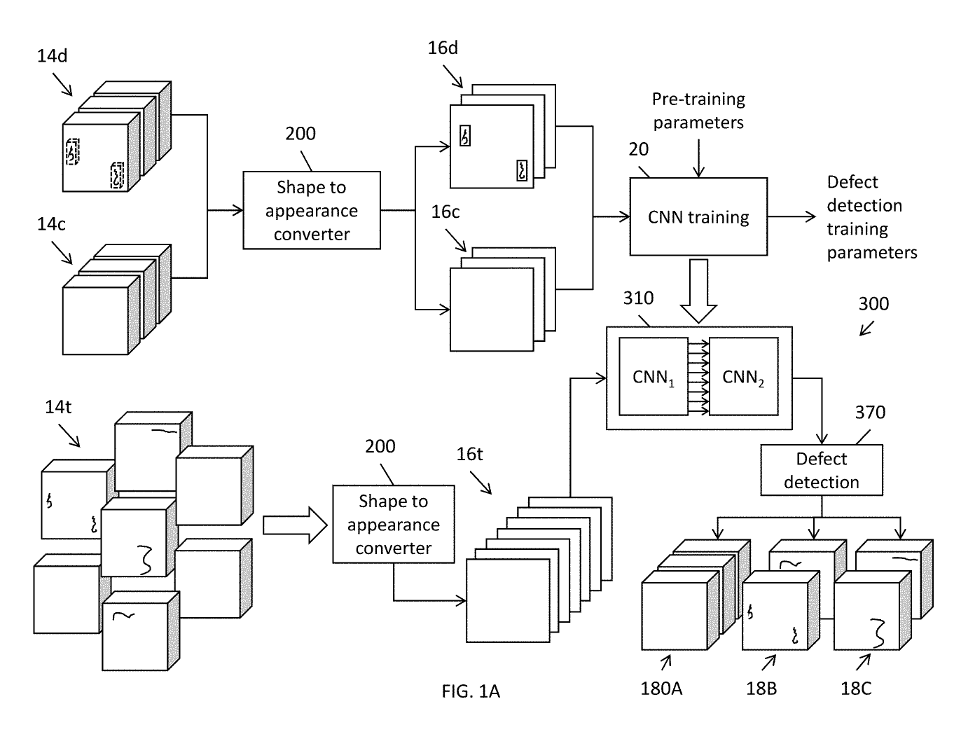

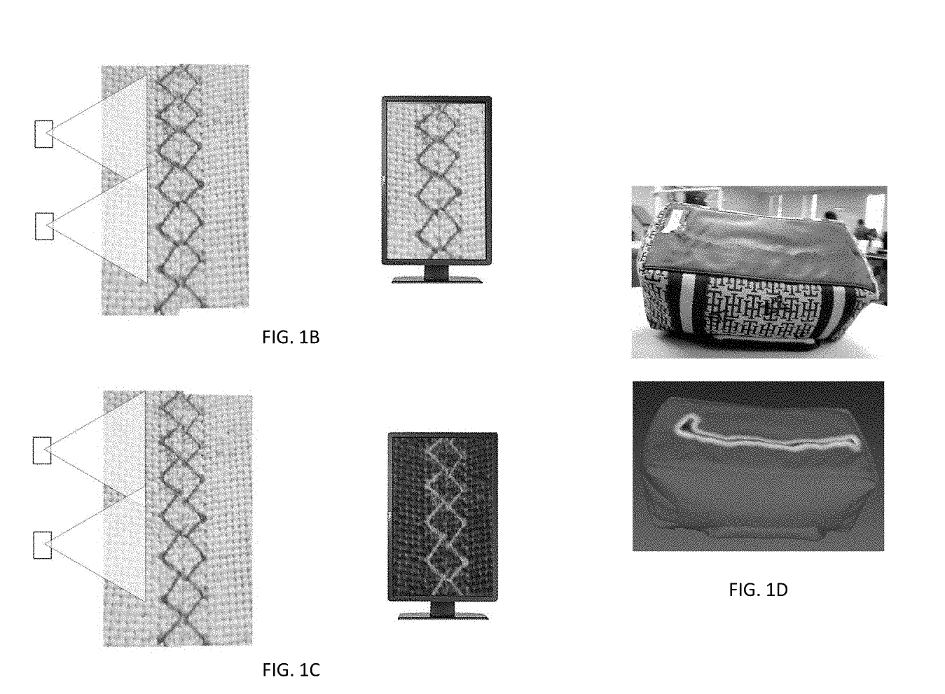

FIG. 1A is a schematic block diagram of a system for training a defect detection system and a system for detecting defects using the trained defect detection system according to one embodiment of the present invention. As shown in FIG. 1A, a system may be trained using labeled training data, which may include captured images of defective objects 14d and captured images of good (or “clean”) objects 14c. The labels may indicate locations and types (or classifications) of defects found on the labeled objects. These training data may correspond to three-dimensional (3-D) data. In some embodiments, a shape to appearance converter 200 converts the 3-D data to two-dimensional (2-D) data (which may be referred to herein as “views” of the object) representing the appearance of the 3-D shapes, where some of the instances correspond to defective objects 16d, and some of the instances correspond to clean objects 16c. In some embodiments, the “views” also include a depth channel, where the value of each pixel of the depth channel represents the distance between the virtual camera and the surface (e.g., of an object in the image) corresponding to the pixel.

The 2-D data, along with their corresponding labels, are supplied to a convolutional neural network (CNN) training module 20, which is configured to train a convolutional neural network 310 for detecting the defects in the training data. The CNN training module 20 may use a pre-trained network (such as a network pre-trained on the ImageNet database Deng, Jia, et al. “ImageNet: A large-scale hierarchical image database.” Computer Vision and Pattern Recognition, 2009. CVPR 2009. IEEE Conference on. IEEE, 2009.).

A defect analysis system 300 can use the trained CNN 310 to classify target objects as having one or more defects based on captured 3-D images 14t of those target objects. In some embodiments, the same shape to appearance converter 200 may be applied to the captured images 14t, and the resulting 2-D appearance data or “views” 16t are supplied to a descriptor extractor, which can use parts or all of the trained CNN 310 to generate at least a portion of a “descriptor.” The descriptor summarizes various aspects of the captured images 14t, thereby allowing defect analysis to be performed on the summary rather than on the full captured image data. A defect detection module 370 may then classify the objects as belonging to one or more classes (shown in FIG. 1A as 18A, 18B, and 18C) corresponding to the absence of defects or the presence of particular types of defects.

Various computational portions of embodiments of the present invention may be implemented through purpose-specific computer instructions executed by a computer system. The computer system may include one or more processors, including one or more central processing units (CPUs), one or more graphics processing units (GPUs), one or more field programmable gate arrays (FPGAs), one or more digital signal processors (DSPs), and/or one or more application specific integrated circuits (ASICs). The computations may be distributed across multiple separate computer systems, some of which may be local to the scanning of the query objects (e.g., on-site and connected directly to the depth and color cameras, or connected to the depth and color cameras over a local area network), and some of which may be remote (e.g., off-site, “cloud” based computing resources connected to the depth and color cameras through a wide area network such as the Internet). For the sake of convenience, the computer systems configured using particular computer instructions to perform purpose specific operations for detecting defects in target objects based on captured images of the target objects are referred to herein as parts of defect detection systems, including shape to appearance converters 200 and defect analysis systems 300.

FIGS. 1B, 1C, and 1D are schematic illustrations of the process of detecting defects in target objects according to some embodiments of the present invention. In FIGS. 1B and 1C, the target object is a portion of a seam of an object, where FIG. 1B depicts a case where the stitching along the seam is within normal tolerances, and therefore the inspection system displays a standard color image of the stitching in a user interface; and where FIG. 1C depicts the case where the stitching is defective, and therefore the inspection system displays the defective stitching with highlights in the user interface. FIG. 1D depicts a bag with a tear in its base panel, where the inspection system displays a user interface where the tear is highlighted in accordance with a heat map overlaid on a three-dimensional (3-D) model of the bag (e.g., in FIG. 1D, portions determined to be more defective are shown in red and yellow, and non-defective or “clean” portions are shown in blue).

Surface Metrology

Some aspects of the process of detecting defects in the surface of an object falls within a class of analysis known as surface metrology. In a quality control portion of a manufacturing process, surface metrology may be used to assess whether a manufactured object (a “test object”) complies with manufacturing specifications, such as by determining whether the differences between object and a reference model object falls within particular tolerance ranges. These tolerances can be defined in different ways, based on the particular standards that are set. For example, the International Standard ISO 1101 for geometrical tolerancing prescribes that that the measured surface of the test object “shall be contained between two equidistant surfaces enveloping spheres of defined diameter equal to the tolerance value, the centres of which are situated on a surface corresponding to the envelope of a sphere in contact with the theoretically exact geometrical form.” This definition can be extended to the case of non-rigid parts as described in the International Standard ISO 10579: “deformation is acceptable provided that the parts may be brought within the indicated tolerance by applying reasonable force to facilitate inspection and assembly.” In some environments and applications, more complex definitions of “tolerance” can be considered. For example, in car bodies, it is important to detect small (e.g., sub-millimeter) dents or bumps (see, e.g., Karbacher, S., Babst, J., Häusler, G., & Laboureux, X. (1999). Visualization and detection of small defects on car-bodies. Modeling and Visualization '99, Sankt Augustin, 1-8.). In other environments and applications, relatively large deformations can be accepted.

Some comparative techniques for automatic free-form surface metrology include mechanical contact methods using, for example, coordinate measuring machines (CMM) (see, e.g., Li, Yadong, and Peihua Gu. “Free-form surface inspection techniques state of the art review.” Computer-Aided Design 36.13 (2004): 1395-1417.). However, such mechanical contact methods are generally slow and can only measure geometric properties on defined sampling grids.

Non-contact methods of surface metrology may use optical sensors such as optical probes (see, e.g., Savio, E., De Chiffre, L., & Schmitt, R. (2007). Metrology of freeform shaped parts. CIRP Annals-Manufacturing Technology, 56(2), 810-835.) and/or line scanners connected to a robotic arm (see, e.g., Sharifzadeh, S., Biro, I., Lohse, N., & Kinnell, P. (2016). Robust Surface Abnormality Detection for a Robotic Inspection System. IFAC-PapersOnLine, 49(21), 301-308.). In addition, 3-D range cameras may also allow for rapid acquisition of the geometry (see, e.g., Lilienblum, E., & Michaelis, B. (2007). Optical 3d surface reconstruction by a multi-period phase shift method. Journal of Computers, 2(2), 73-83. and Dal Mutto, C., Zanuttigh, P., & Cortelazzo, G. M. (2012). Time-of-Flight Cameras and Microsoft Kinect™. Springer Science & Business Media.)

Often, the reference model surface is defined in parametric form such as non-uniform rational B-spline (NURBS), typically from a computer aided design (CAD) model. The acquired 3-D data of the object is then aligned with the reference model in order to compute surface discrepancy (see, e.g., Prieto, F., Redarce, T., Lepage, R., & Boulanger, P. (2002). An automated inspection system. The International Journal of Advanced Manufacturing Technology, 19(12), 917-925. and Prieto, F., Redarce, H. T., Lepage, R., & Boulanger, P. (1998). Visual system for fast and automated inspection of 3-D parts. International Journal of CAD/CAM and Computer Graphics, 13(4), 211-227.). In some cases, however, a reference CAD model is not available, in the model surface cannot be well modeled in CAD, or small deformations are expected and should be tolerated. In these cases, one can measure (e.g. using a 3-D range camera) multiple surfaces from a number of defect-free samples of the same part, where the acquired surfaces have been aligned (e.g. using the iterative closest point algorithm[00121]). Then, a model that represents the expected geometric variation can be built. For example, some comparative techniques compute the B-spline representation of each aligned model surface (represented as a range or depth image), then applies the Karhunen-Loeve Transform (KLT), obtaining a small-dimensional subspace that captures the most significant geometric variations (see, e.g., von Enzberg, S., & Michaelis, B. (2012, August). Surface Quality Inspection of Deformable Parts with Variable B-Spline Surfaces. In Joint DAGM (German Association for Pattern Recognition) and OAGM Symposium (pp. 175-184). Springer Berlin Heidelberg.). When a test surface is measured, its B-spline representation is projected onto this subspace, resulting in an appropriate “model” range image that is then compared to the test surface. This comparison can be performed, for example, by computing the difference in depth between the two depth images (i.e., images taken by a depth camera, where each pixel measures the distance along one line of sight of the closest surface point). This difference can be segmented to detect potential surface defects, which can then be then analyzed using a support vector machine (SVM) classifier (see, e.g., von Enzberg, S., & Al-Hamadi, A. (2014, August). A defect recognition system for automated inspection of non-rigid surfaces. In Pattern Recognition (ICPR), 2014 22nd International Conference on (pp. 1812-1816). IEEE.).

Computing the discrepancy between depth images may be appropriate when only the frontal view of a part is considered. A different approach may be used when comparing two general surfaces, which can be obtained, for example, from scanning an object with multiple range cameras. In these cases, a single depth image may be unable to represent the geometry of the surface, and therefore richer representations (e.g., triangular meshes) may be used instead. One approach to computing the discrepancy between two general surfaces is to compute the Haussdorf distance between the points in the two aligned surfaces (or in selected matching parts thereof) (see, e.g., Cignoni, P., Rocchini, C., & Scopigno, R. (1998, June). Metro: measuring error on simplified surfaces. In Computer Graphics Forum (Vol. 17, No. 2, pp. 167-174). Blackwell Publishers.). Algorithms for measuring errors have been devised for surfaces represented as triangular meshes (see, e.g., Aspert, N., Santa Cruz, D., & Ebrahimi, T. (2002). MESH: measuring errors between surfaces using the Hausdorff distance. ICME (1), 705-708.), and some techniques consider surface curvature in the computation of surface discrepancy (see, e.g., Zhou, L., & Pang, A. (2001). Metrics and visualization tools for surface mesh comparison. Photonics West 2001-Electronic Imaging, 99-110.).

Besides surface metrology, the appearance (texture and color) of the surfaces can be a parameter of importance for quality assurance. See, e.g., Ngan, H. Y., Pang, G. K., & Yung, N. H. (2011). Automated fabric defect detection—a review. Image and Vision Computing, 29(7), 442-458.

Aspects of embodiments of the present invention are directed to systems and methods for defect detection that apply a trained descriptor extractor (e.g., a portion of a trained neural network) to extract a summary descriptor of the surface of the object from the data and performing the defect analysis based on the descriptor, rather than comparing the captured data to a reference model. Embodiments of the present invention improve the speed of the defect detection system by, for example, reducing the size of the data to be compared and by enabling a more adaptable definition of the tolerances of products, thereby allowing automatic defect detection to be applied to products that inherently exhibit greater variance, such as pliable objects (e.g., items made of fabric and/or soft plastic, such as handbags and shoes), where a distance between a measured surface and a nominal, reference surface does not necessarily signal the presence of a defect.

As a specific example, in the case of a leather handbag, some parts are sewn together by design to produce folds in the handbag. These folds may be an essential feature of the bag's appearance, and may develop uniquely for each unit due to variations in the particular location of the stitches, the natural variations in the stiffness of the leather in different parts of the bag, and the particular way in which the bag is resting when it is scanned. As such, simply comparing the location of the surface of a scanned bag to a reference model e.g., by measuring a Haussdorf distance as described above), or other standard metrics would likely result in detecting too many defects (due to the wide variation in possible shapes) but may also fail to detect particular types of defects (e.g., too many folds or folds that are too tight).

As another example, in the quality inspection process for car seats in a production line, multiple possible defect classes may be defined, including: wrinkles at panels or at seams; puckers at seams; knuckles or waves at the zipper sew; bumps on side panels; bagginess in trims; bad seam alignment; misaligned panels; and gaps on zippers or between adjoining parts. In addition, defects may exist in the fabric material itself or on its installation, such as visible needle holes, hanging threads, loop threads, frayed threads, back tacks, bearding, and misaligned perforations. Some of these defects types can be quantified, and the measured quantities may be used to determine whether a car seat is acceptable, requires fixing, or must be discarded. For example, one acceptance criterion could be that any given panel should have no more than two wrinkles of up to 40 mm in length and no more than 5 wrinkles up to 25 mm in length. Other criteria may involve the maximum gap at a zipper or the maximum depth of a seam. The ability to quantify specific characteristics of a “defect” enables qualification of its severity. For example, based on displayed information about a detected and quantified defect, a quality assurance (QA) professional could mark a certain car seat as “moderately defective,” deferring the final decision about acceptance of this seat to a later time.

As such, aspects of embodiments of the present invention relate to a system and method for automatically detecting defects in objects and automatically classifying and/or quantifying the defects. Aspects of embodiments of the present invention may be applied to non-rigid, pliable materials, although embodiments of the present invention are not limited thereto. In various embodiments of the present invention, a 3-D textured model of the object is acquired by a single range (or depth) camera at a fixed location, by a single range camera that is moved to scan the object, or by an array or group of range cameras placed around the object. The process of acquiring the 3-D surface of an object by whichever means will be called “3-D scanning” herein.

In some embodiments of the present invention, to perform defect detection the nominal, reference surface of the object is made available (e.g., provided by the user of the system), for example in the form of a CAD model. In another embodiment, one or more examples of non-defective or clean objects are made available (e.g., provided by the user of the defect detection system, such as the manufacturing facility at which the defect detection system is installed); these units can be 3-D scanned, allowing and the system is trained based on the characteristics of the object's nominal surface. In addition, the defect detection system is provided with a number of defective units of the same object, in which the nature of each defect is clearly specified (e.g., including the locations and types of the defects). The defective samples are 3-D scanned; the resulting 3-D models can be processed to extract “descriptors” that help the system to automatically discriminate between defective and non-defective parts, as described in more detail below.

In some embodiments, the defect detection system uses these descriptors to detect relevant “features” of the object (or portion of the object) under exam. For example, the defect detection system can identify individual folds or wrinkles of the surface, or a zipper line, or the junction between a handle and a panel. Defects can then be defined based on these features, such as by counting the number of detected wrinkles within a certain area and/or by measuring the lengths of the wrinkles.

Capturing Depth Images of Objects

Aspects of embodiments of the present invention relate to the use of an array of range cameras to acquire information about the shape and texture of the surface of an object. A range camera measures the distance of visible surface points, and enables reconstruction of a portion of a surface seen by the camera in the form of a cloud of 3-D points. Multiple range cameras can be placed at different locations and orientations (or “poses”) in order to acquire data about a larger portion of an object. If the cameras are geometrically calibrated, then the point clouds generated from the different views can be rigidly moved to a common reference system, effectively obtaining a single cumulative 3-D reconstruction. If the cameras are not registered, or if the registration is not expected to be accurate, the 3-D point clouds can be aligned using standard procedures such as the Iterated Closest Point algorithm (see, e.g., Besl, Paul J., and Neil D. McKay. “Method for registration of 3-D shapes.” Sensor Fusion IV: Control Paradigms and Data Structures. Vol. 1611. International Society for Optics and Photonics, 1992.). Color cameras can also be used to acquire the appearance of a surface under a particular illuminant. This information can be useful in situations where the image texture or color may reveal specific defects. If the color cameras are geometrically calibrated with the range cameras, color information can be re-mapped on the acquired 3-D surface using standard texturization procedures.

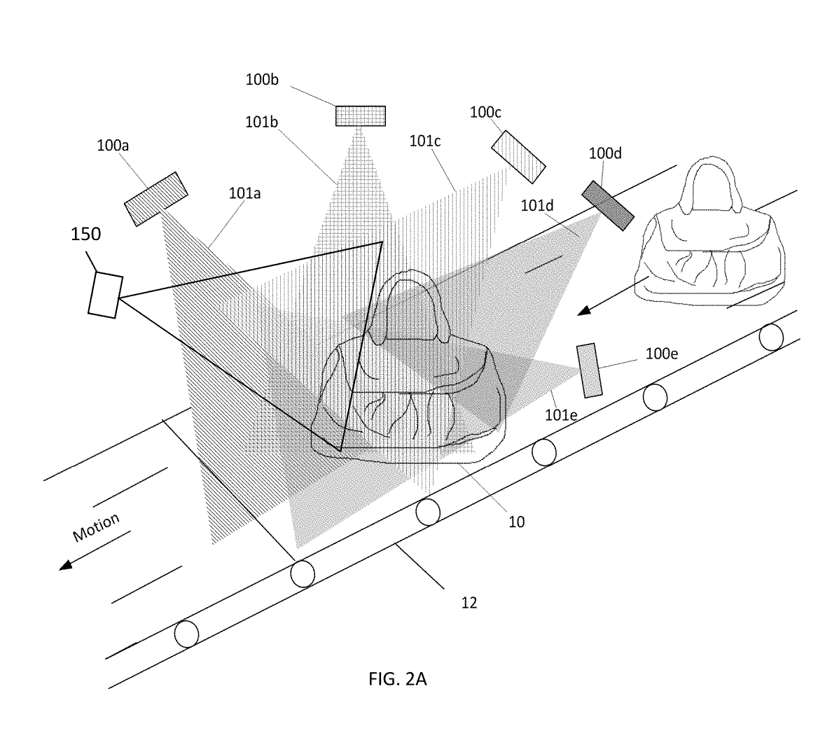

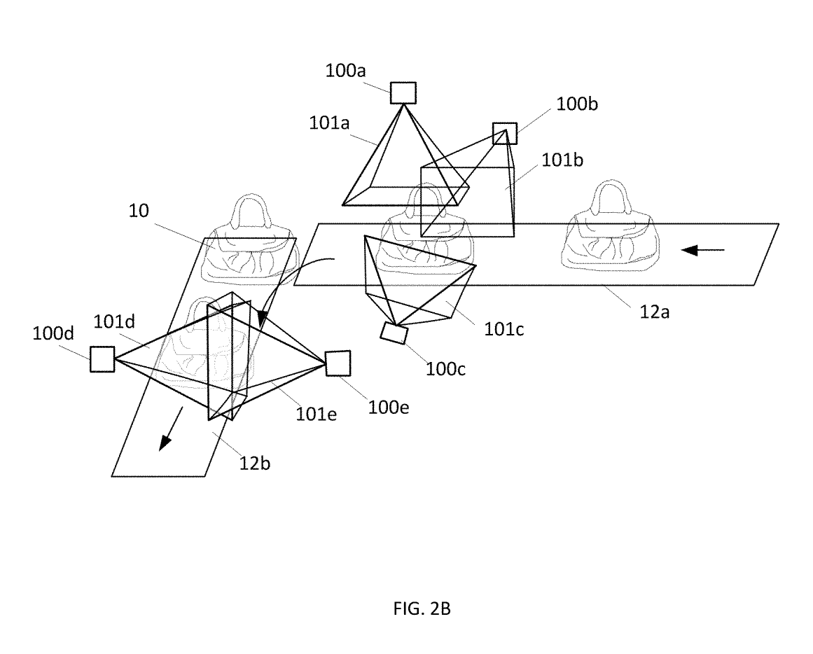

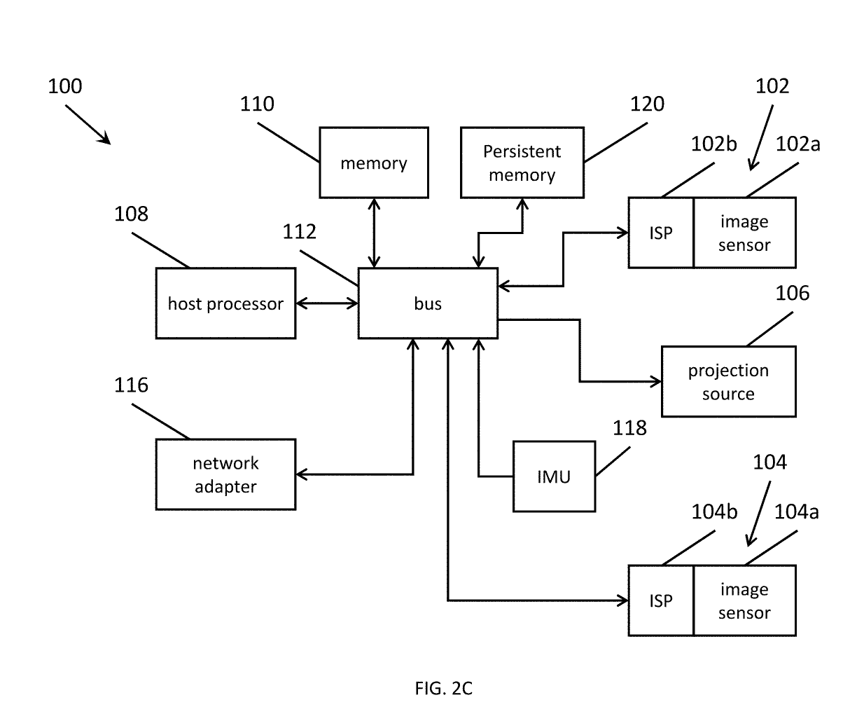

FIG. 2A is a schematic depiction of an object 10 (illustrated as a handbag) traveling on a conveyor belt 12 with a plurality of (five) cameras 100 (labeled 100a, 100b, 100c, 100d, and 100e) concurrently imaging the object according to one embodiment of the present invention. The fields of view 101 of the cameras (labeled 101a, 101b, 101c, 101d, and 101e) are depicted as triangles with different shadings, and illustrate the different views (e.g., surfaces) of the object that are captured by the cameras 100. The cameras 100 may include both color and infrared (IR) imaging units to capture both geometric and texture properties of the object. The cameras 100 may be arranged around the conveyor belt 12 such that they do not obstruct the movement of the object 10 as the object moves along the conveyer belt 12. In some embodiments, one or more color cameras 150 may be also be arranged around the conveyor belt to image the object 10.

The cameras may be stationary and configured to capture images when at least a portion of the object 10 enters their respective fields of view (FOVs) 101. The cameras 100 may be arranged such that the combined FOVs 101 of cameras cover all critical (e.g., visible) surfaces of the object 10 as it moves along the conveyor belt 12 and at a resolution appropriate for the purpose of the captured 3-D model (e.g., with more detail around the stitching that attaches the handle to the bag).

As one example of an arrangement of cameras, FIG. 2B is a schematic depiction of an object 10 (depicted as a handbag) traveling on a conveyor belt 12 having two portions, where the first portion moves the object 10 along a first direction and the second portion moves the object 10 along a second direction that is orthogonal to the first direction in accordance with one embodiment of the present invention. When the object 10 travels along the first portion 12a of the conveyor belt 12, a first camera 100a images the top surface of the object 10 from above, while second and third cameras 100b and 100c image the sides of the object 10. In this arrangement, it may be difficult to image the ends of the object 10 because doing so would require placing the cameras along the direction of movement of the conveyor belt and therefore may obstruct the movement of the objects 10. As such, the object 10 may transition to the second portion 12b of the conveyor belt 12, where, after the transition, the end of the object 10 are now visible to cameras 100d and 100e located on the sides of the second portion 12b of the conveyor belt 12. As such, FIG. 2B illustrates an example of an arrangement of cameras that allows coverage of the entire visible surface of the object 10.

In circumstances where the cameras are stationary (e.g., have fixed locations), the relative poses of the cameras 100 can be estimated a priori, thereby improving the pose estimation of the cameras, and the more accurate pose estimation of the cameras improves the result of 3-D reconstruction algorithms that merge the separate partial point clouds generated from the separate depth cameras.

Systems and methods for capturing images of objects conveyed by a conveyor system are described in more detail in U.S. patent application Ser. No. 15/866,217, “Systems and Methods for Defect Detection,” filed in the United States Patent and Trademark Office on Jan. 9, 2018, the entire disclosure of which is incorporated by reference herein.

Depth Cameras

In some embodiments of the present invention, the range cameras 100, also known as “depth cameras,” include at least two standard two-dimensional cameras that have overlapping fields of view. In more detail, these two-dimensional (2-D) cameras may each include a digital image sensor such as a complementary metal oxide semiconductor (CMOS) image sensor or a charge coupled device (CCD) image sensor and an optical system (e.g., one or more lenses) configured to focus light onto the image sensor. The optical axes of the optical systems of the 2-D cameras may be substantially parallel such that the two cameras image substantially the same scene, albeit from slightly different perspectives. Accordingly, due to parallax, portions of a scene that are farther from the cameras will appear in substantially the same place in the images captured by the two cameras, whereas portions of a scene that are closer to the cameras will appear in different positions.

Using a geometrically calibrated depth camera, it is possible to identify the 3-D locations of all visible points on the surface of the object with respect to a reference coordinate system (e.g., a coordinate system having its origin at the depth camera). Thus, a range image or depth image captured by a range camera 100 can be represented as a “cloud” of 3-D points, which can be used to describe the portion of the surface of the object (as well as other surfaces within the field of view of the depth camera).

FIG. 2C is a block diagram of a stereo depth camera system according to one embodiment of the present invention. The depth camera system 100 shown in FIG. 2C includes a first camera 102, a second camera 104, a projection source 106 (or illumination source or active projection system), and a host processor 108 and memory 110, wherein the host processor may be, for example, a graphics processing unit (GPU), a more general purpose processor (CPU), an appropriately configured field programmable gate array (FPGA), or an application specific integrated circuit (ASIC). The first camera 102 and the second camera 104 may be rigidly attached, e.g., on a frame, such that their relative positions and orientations are substantially fixed. The first camera 102 and the second camera 104 may be referred to together as a “depth camera.” The first camera 102 and the second camera 104 include corresponding image sensors 102a and 104a, and may also include corresponding image signal processors (ISP) 102b and 104b. The various components may communicate with one another over a system bus 112. The depth camera system 100 may include additional components such as a network adapter 116 to communicate with other devices, an inertial measurement unit (IMU) 118 such as a gyroscope to detect acceleration of the depth camera 100 (e.g., detecting the direction of gravity to determine orientation), and persistent memory 120 such as NAND flash memory for storing data collected and processed by the depth camera system 100. The IMU 118 may be of the type commonly found in many modern smartphones. The image capture system may also include other communication components, such as a universal serial bus (USB) interface controller.

Although the block diagram shown in FIG. 2C depicts a depth camera 100 as including two cameras 102 and 104 coupled to a host processor 108, memory 110, network adapter 116, IMU 118, and persistent memory 120, embodiments of the present invention are not limited thereto. For example, the three depth cameras 100 shown in FIG. 2A may each merely include cameras 102 and 104, projection source 106, and a communication component (e.g., a USB connection or a network adapter 116), and processing the two-dimensional images captured by the cameras 102 and 104 of the three depth cameras 100 may be performed by a shared processor or shared collection of processors in communication with the depth cameras 100 using their respective communication components or network adapters 116.

In some embodiments, the image sensors 102a and 104a of the cameras 102 and 104 are RGB-IR image sensors. Image sensors that are capable of detecting visible light (e.g., red-green-blue, or RGB) and invisible light (e.g., infrared or IR) information may be, for example, charged coupled device (CCD) or complementary metal oxide semiconductor (CMOS) sensors. Generally, a conventional RGB camera sensor includes pixels arranged in a “Bayer layout” or “RGBG layout,” which is 50% green, 25% red, and 25% blue. Band pass filters (or “micro filters”) are placed in front of individual photodiodes (e.g., between the photodiode and the optics associated with the camera) for each of the green, red, and blue wavelengths in accordance with the Bayer layout. Generally, a conventional RGB camera sensor also includes an infrared (IR) filter or IR cut-off filter (formed, e.g., as part of the lens or as a coating on the entire image sensor chip) which further blocks signals in an IR portion of electromagnetic spectrum.

An RGB-IR sensor is substantially similar to a conventional RGB sensor, but may include different color filters. For example, in an RGB-IR sensor, one of the green filters in every group of four photodiodes is replaced with an IR band-pass filter (or micro filter) to create a layout that is 25% green, 25% red, 25% blue, and 25% infrared, where the infrared pixels are intermingled among the visible light pixels. In addition, the IR cut-off filter may be omitted from the RGB-IR sensor, the IR cut-off filter may be located only over the pixels that detect red, green, and blue light, or the IR filter can be designed to pass visible light as well as light in a particular wavelength interval (e.g., 840-860 nm). An image sensor capable of capturing light in multiple portions or bands or spectral bands of the electromagnetic spectrum (e.g., red, blue, green, and infrared light) will be referred to herein as a “multi-channel” image sensor.

In some embodiments of the present invention, the image sensors 102a and 104a are conventional visible light sensors. In some embodiments of the present invention, the system includes one or more visible light cameras (e.g., RGB cameras) and, separately, one or more invisible light cameras (e.g., infrared cameras, where an IR band-pass filter is located across all over the pixels). In other embodiments of the present invention, the image sensors 102a and 104a are infrared (IR) light sensors.

In some embodiments in which the depth cameras 100 include color image sensors (e.g., RGB sensors or RGB-IR sensors), the color image data collected by the depth cameras 100 may supplement the color image data captured by the color cameras 150. In addition, in some embodiments in which the depth cameras 100 include color image sensors (e.g., RGB sensors or RGB-IR sensors), the color cameras 150 may be omitted from the system.

Generally speaking, a stereoscopic depth camera system includes at least two cameras that are spaced apart from each other and rigidly mounted to a shared structure such as a rigid frame. The cameras are oriented in substantially the same direction (e.g., the optical axes of the cameras may be substantially parallel) and have overlapping fields of view. These individual cameras can be implemented using, for example, a complementary metal oxide semiconductor (CMOS) or a charge coupled device (CCD) image sensor with an optical system (e.g., including one or more lenses) configured to direct or focus light onto the image sensor. The optical system can determine the field of view of the camera, e.g., based on whether the optical system is implements a “wide angle” lens, a “telephoto” lens, or something in between.

In the following discussion, the image acquisition system of the depth camera system may be referred to as having at least two cameras, which may be referred to as a “master” camera and one or more “slave” cameras. Generally speaking, the estimated depth or disparity maps computed from the point of view of the master camera, but any of the cameras may be used as the master camera. As used herein, terms such as master/slave, left/right, above/below, first/second, and CAM1/CAM2 are used interchangeably unless noted. In other words, any one of the cameras may be master or a slave camera, and considerations for a camera on a left side with respect to a camera on its right may also apply, by symmetry, in the other direction. In addition, while the considerations presented below may be valid for various numbers of cameras, for the sake of convenience, they will generally be described in the context of a system that includes two cameras. For example, a depth camera system may include three cameras. In such systems, two of the cameras may be invisible light (infrared) cameras and the third camera may be a visible light (e.g., a red/blue/green color camera) camera. All three cameras may be optically registered (e.g., calibrated) with respect to one another. One example of a depth camera system including three cameras is described in U.S. patent application Ser. No. 15/147,879 “Depth Perceptive Trinocular Camera System” filed in the United States Patent and Trademark Office on May 5, 2016, the entire disclosure of which is incorporated by reference herein.

To detect the depth of a feature in a scene imaged by the cameras, the depth camera system determines the pixel location of the feature in each of the images captured by the cameras. The distance between the features in the two images is referred to as the disparity, which is inversely related to the distance or depth of the object. (This is the effect when comparing how much an object “shifts” when viewing the object with one eye at a time—the size of the shift depends on how far the object is from the viewer's eyes, where closer objects make a larger shift and farther objects make a smaller shift and objects in the distance may have little to no detectable shift.) Techniques for computing depth using disparity are described, for example, in R. Szeliski. “Computer Vision: Algorithms and Applications”, Springer, 2010 pp. 467 et seq.

The magnitude of the disparity between the master and slave cameras depends on physical characteristics of the depth camera system, such as the pixel resolution of cameras, distance between the cameras and the fields of view of the cameras. Therefore, to generate accurate depth measurements, the depth camera system (or depth perceptive depth camera system) is calibrated based on these physical characteristics.

In some depth camera systems, the cameras may be arranged such that horizontal rows of the pixels of the image sensors of the cameras are substantially parallel. Image rectification techniques can be used to accommodate distortions to the images due to the shapes of the lenses of the cameras and variations of the orientations of the cameras.

In more detail, camera calibration information can provide information to rectify input images so that epipolar lines of the equivalent camera system are aligned with the scanlines of the rectified image. In such a case, a 3-D point in the scene projects onto the same scanline index in the master and in the slave image. Let uₘ and uₛ be the coordinates on the scanline of the image of the same 3-D point p in the master and slave equivalent cameras, respectively, where in each camera these coordinates refer to an axis system centered at the principal point (the intersection of the optical axis with the focal plane) and with horizontal axis parallel to the scanlines of the rectified image. The difference uₛ−uₘ is called disparity and denoted by d; it is inversely proportional to the orthogonal distance of the 3-D point with respect to the rectified cameras (that is, the length of the orthogonal projection of the point onto the optical axis of either camera).

Stereoscopic algorithms exploit this property of the disparity. These algorithms achieve 3-D reconstruction by matching points (or features) detected in the left and right views, which is equivalent to estimating disparities. Block matching (BM) is a commonly used stereoscopic algorithm. Given a pixel in the master camera image, the algorithm computes the costs to match this pixel to any other pixel in the slave camera image. This cost function is defined as the dissimilarity between the image content within a small window surrounding the pixel in the master image and the pixel in the slave image. The optimal disparity at point is finally estimated as the argument of the minimum matching cost. This procedure is commonly addressed as Winner-Takes-All (WTA). These techniques are described in more detail, for example, in R. Szeliski. “Computer Vision: Algorithms and Applications”, Springer, 2010. Since stereo algorithms like BM rely on appearance similarity, disparity computation becomes challenging if more than one pixel in the slave image have the same local appearance, as all of these pixels may be similar to the same pixel in the master image, resulting in ambiguous disparity estimation. A typical situation in which this may occur is when visualizing a scene with constant brightness, such as a flat wall.

Methods exist that provide additional illumination by projecting a pattern that is designed to improve or optimize the performance of block matching algorithm that can capture small 3-D details such as the one described in U.S. Pat. No. 9,392,262 “System and Method for 3-D Reconstruction Using Multiple Multi-Channel Cameras,” issued on Jul. 12, 2016, the entire disclosure of which is incorporated herein by reference. Another approach projects a pattern that is purely used to provide a texture to the scene and particularly improve the depth estimation of texture-less regions by disambiguating portions of the scene that would otherwise appear the same.

The projection source 106 according to embodiments of the present invention may be configured to emit visible light (e.g., light within the spectrum visible to humans and/or other animals) or invisible light (e.g., infrared light) toward the scene imaged by the cameras 102 and 104. In other words, the projection source may have an optical axis substantially parallel to the optical axes of the cameras 102 and 104 and may be configured to emit light in the direction of the fields of view of the cameras 102 and 104. In some embodiments, the projection source 106 may include multiple separate illuminators, each having an optical axis spaced apart from the optical axis (or axes) of the other illuminator (or illuminators), and spaced apart from the optical axes of the cameras 102 and 104.

An invisible light projection source may be better suited to for situations where the subjects are people (such as in a videoconferencing system) because invisible light would not interfere with the subject's ability to see, whereas a visible light projection source may shine uncomfortably into the subject's eyes or may undesirably affect the experience by adding patterns to the scene. Examples of systems that include invisible light projection sources are described, for example, in U.S. patent application Ser. No. 14/788,078 “Systems and Methods for Multi-Channel Imaging Based on Multiple Exposure Settings,” filed in the United States Patent and Trademark Office on Jun. 30, 2015, the entire disclosure of which is herein incorporated by reference.

Active projection sources can also be classified as projecting static patterns, e.g., patterns that do not change over time, and dynamic patterns, e.g., patterns that do change over time. In both cases, one aspect of the pattern is the illumination level of the projected pattern. This may be relevant because it can influence the depth dynamic range of the depth camera system. For example, if the optical illumination is at a high level, then depth measurements can be made of distant objects (e.g., to overcome the diminishing of the optical illumination over the distance to the object, by a factor proportional to the inverse square of the distance) and under bright ambient light conditions. However, a high optical illumination level may cause saturation of parts of the scene that are close-up. On the other hand, a low optical illumination level can allow the measurement of close objects, but not distant objects.

Although embodiments of the present invention are described herein with respect to stereo depth camera systems, embodiments of the present invention are not limited thereto and may also be used with other depth camera systems such as structured light time of flight cameras and LIDAR cameras.

Depending on the choice of camera, different techniques may be used to generate the 3-D model. For example, Dense Tracking and Mapping in Real Time (DTAM) uses color cues for scanning and Simultaneous Localization and Mapping (SLAM) uses depth data (or a combination of depth and color data) to generate the 3-D model.

Detecting Defects

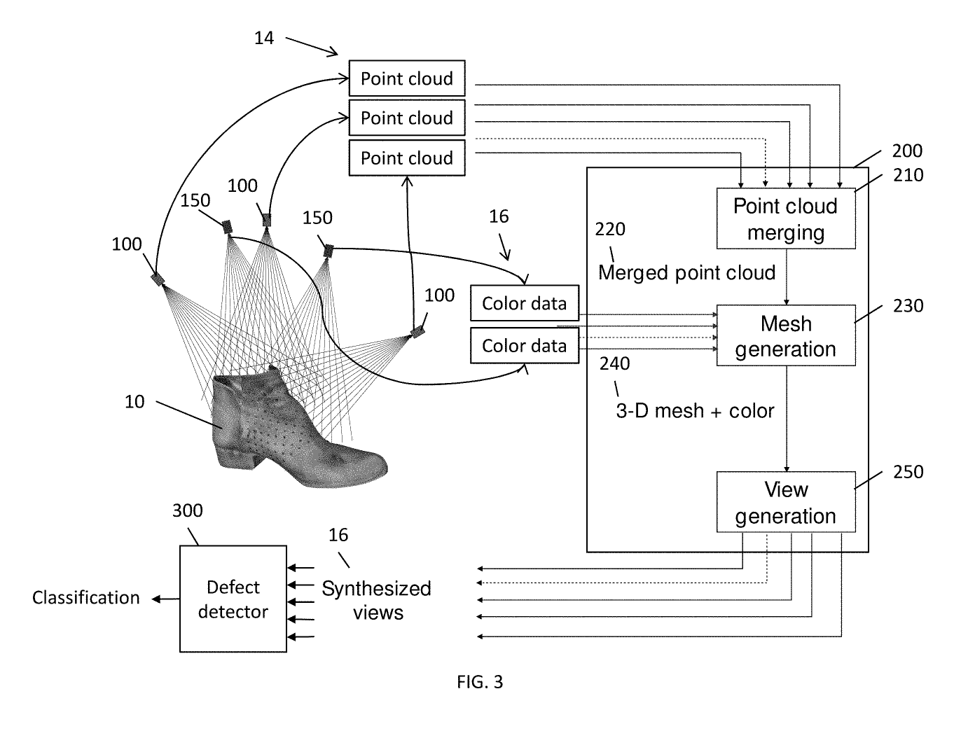

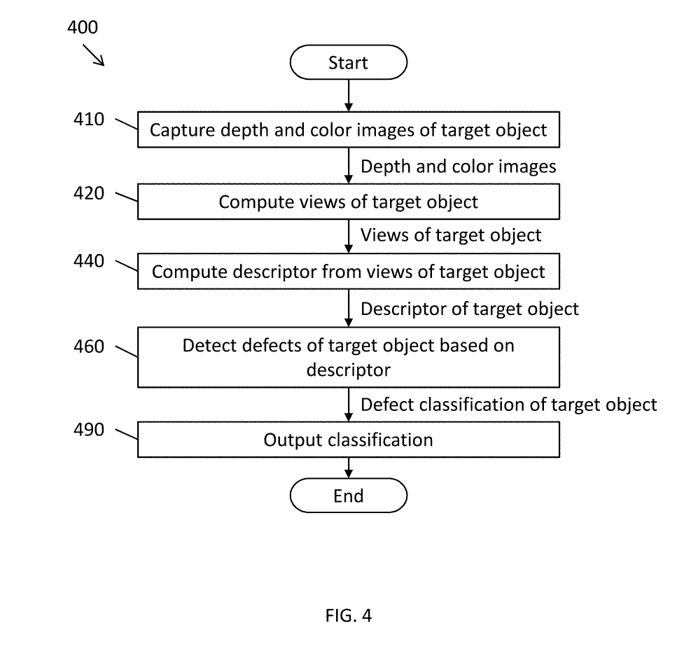

FIG. 3 is a schematic block diagram illustrating a process for capturing images of an object and detecting defects in the object according to one embodiment of the present invention. FIG. 4 is a flowchart of a method for detecting defects in an object according to one embodiment of the present invention.

Referring to FIGS. 3 and 4, according to some embodiments, in operation 410, the processor controls the depth (or “range”) cameras 100 to capture depth images 14 (labeled as “point clouds” in FIG. 3) of the target object 10. In some embodiments, color (e.g., red, green, blue or RGB) cameras 150 are also used to captured additional color images of the cameras. (In some embodiments, the depth cameras 100 include color image sensors and therefore also capture color data without the need for separate color cameras 150.) The data captured by the range cameras 100 and the color cameras 150 (RGB cameras) that image are used to build a representation of the object 10 which is summarized in a feature vector or “descriptor” F. In some embodiments, each of the depth cameras 100 generates a three-dimensional (3-D) point cloud 14 (e.g., a collection of three dimensional coordinates representing points on the surface of the object 10 that are visible from the pose of the corresponding one of the depth cameras 100) and the descriptor F is extracted from the generated 3-D model.

Descriptor Extraction

As discussed above, one aspect of embodiments of the present invention relates to performing defect analysis on a “descriptor” rather than the 3-D surface of the object itself. In some embodiments, the descriptor is a vector of numbers that represents features detected on the entire scanned surface of the object (or a portion of the entire scanned surface of the object), where a further defect detection system can infer the presence or absence of defects based on those features. In some embodiments of the present invention, the size of the descriptor (e.g., in bits) is smaller than the size (e.g., in bits) of the captured image data of the surface of the object, thereby reducing the complexity in the processing of the data for defect detection.

For example, in some embodiments, the descriptor is supplied to a binary classifier that is configured to determine the presence or absence of a defect. In some embodiments, the descriptor of a target object is compared against a descriptor corresponding to one or more non-defective or clean objects, and any discrepancy or distance between the descriptor of the target object and the one or more descriptors of the non-defective objects is used as an indication of the possible presence of a defect. As still another example, the descriptor may be used to detect defects using explicit, formal rules such as the number of or lengths of folds, gaps, and zipper lines in the target object. In some embodiments of the present invention, the descriptor is extracted, at least in part, using a convolutional neural network.

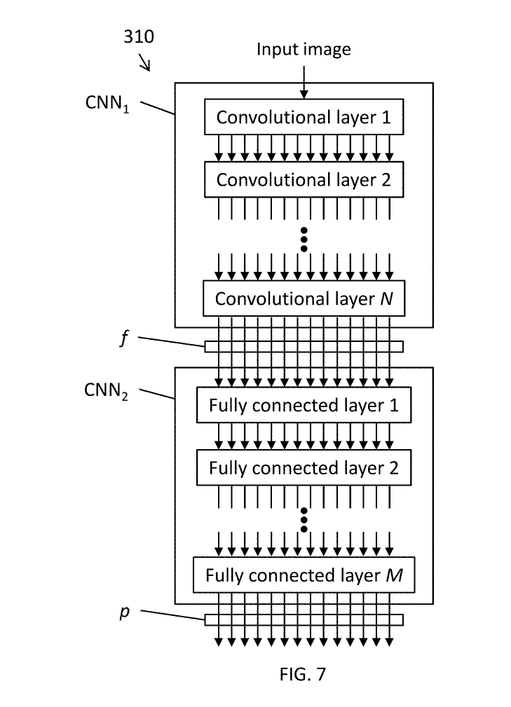

Typically, a convolutional neural network (CNN) includes a plurality of convolutional layers followed by one or more fully connected layers (see, e.g., the CNN 310 shown in FIG. 7, which depicts convolutional layers CNN₁ and fully connected layers CNN₂). In some convolutional neural networks, the input data is a two-dimensional array of values (e.g., an image) and the output of the fully connected layers is a vector having a length equal to the number of classes to be considered; where the value of the n-th entry of the output vector represent the probability that the input data belongs to (e.g., contains an instance of) the n-th class. As a specific example, the CNN may be trained to detect one or more possible surface features of a handbag, such as zippers, buttons, stitching, tears, and the like, and the output of the CNN may include a determination as to whether the input data includes portions that correspond to those elements. In some circumstances, the output of the CNN is a 2-D array of vectors, where the n-th entry of the vector for a given position (or pixel) in the matrix corresponds to a probability that the corresponding pixel belongs to the n-th class (e.g., the probability that a given pixel is a part of a wrinkle). As such, a CNN can be used to “segment” the input data to identify specific areas of interest (e.g., the presence of a set of wrinkles on the surface).

A CNN can also be “decapitated” by removing the fully connected layers (e.g., CNN₂ in FIG. 7). In some embodiments, the vector in output from the convolutional layers or convolutional stage (e.g., CNN₁) can be used as a descriptor vector for the applications described above. For example, descriptor vectors thus obtained can be used to compare different surfaces, by computing the distance between such vectors, as described in more detail below. Systems and methods involving the use of a “decapitated” CNN are described in more detail in U.S. patent application Ser. No. 15/862,512, “Shape-Based Object Retrieval and Classification,” filed in the United States Patent and Trademark Office on Jan. 4, 2018, the entire disclosure of which is incorporated by reference herein.

Generally, CNNs are used to analyze images (2-D arrays). Depth images, where each pixel in the depth image includes a depth value or a distance value representing the distance between a depth camera and the surface of the object represented by the pixel (e.g., along the line of sight represented by the pixel), can also be processed by a CNN, as discussed in Gupta, S., Girshick, R., Arbeláez, P., & Malik, J. (2014, September). Learning rich features from RGB-D images for object detection and segmentation. In European Conference on Computer Vision (pp. 345-360). Springer International Publishing.

On the other hand, different techniques may be needed to adapt a 3-D model (e.g., a collection of 3-D points or a 3-D triangular mesh) for use with a CNN. For example, a 3-D surface can be encoded with a volumetric representation, which can be then processed by a specially designed CNN (see, e.g., Qi, C. R., Su, H., Nieβner, M., Dai, A., Yan, M., & Guibas, L. J. (2016). Volumetric and multi-view CNNs for object classification on 3-D data. In Proceedings of the IEEE Conference on Computer Vision and Pattern Recognition (pp. 5648-5656) and Maturana, D., & Scherer, S. (2015, September). Voxnet: A 3d convolutional neural network for real-time object recognition. In Intelligent Robots and Systems (IROS), 2015 IEEE/RSJ International Conference on (pp. 922-928). IEEE.). Standard CNNs operating on 2-D images can still be used if the 3-D data is pre-processed so as to be represented by a set of 2-D images.

One option is to synthetically generate a number of views of the surface as seen by different virtual cameras placed at specific locations and at specific orientations (see, e.g., Su, H., Maji, S., Kalogerakis, E., & Learned-Miller, E. (2015). Multi-view convolutional neural networks for 3d shape recognition. In Proceedings of the IEEE International Conference on Computer vision (pp. 945-953).). For example, virtual cameras can be placed on the surface of a sphere around an object, oriented towards a common point in space. An image is rendered from the perspective of each virtual camera under specific assumptions about the reflectivity properties of the object's surface, as well as on the scene illuminant. As an example, one could assume that the surface has Lambertian (matte) reflection characteristics, and that it is illuminated by a point source located at a specific point in space. The collection of the images generated in this way forms a characteristic description of the surface, and enables processing using algorithms that take 2-D data (images) as input.

Various options are available to integrate data from the multiple images obtained of the 3-D surface from different viewpoints. For example, the method in [00111] processes all individual images with an identical convolutional architecture; data from these parallel branches is then integrated using a max-pooling module, obtaining an individual descriptor vector that is representative of the surface being analyzed.

Accordingly, aspects of embodiments of the present invention are directed to systems and methods for generating views from scans of objects, where the views are tailored for use in descriptor extraction and defect detection.

Shape to Appearance Conversion

Referring to FIG. 4, in operation 420, the shape to appearance converter 200 computes views (e.g., 2-D representations) of the target object.

One relevant factor when analyzing 3-D shapes is their pose (location and orientation), defined with respect to a fixed frame of reference (e.g., the reference frame at one of the range cameras observing the shape). This is particularly important when comparing two shapes, which, for proper results, should be aligned with each other (meaning that they have the same pose).

In some embodiments of the present invention, it is possible to ensure that the object being analyzed is aligned to a “canonical” pose (e.g. if the object is placed on a conveyor belt in a fixed position). In other cases, it is possible to align the acquired 3-D data with a model shape, using standard algorithms such as iterative closest point (ICP).

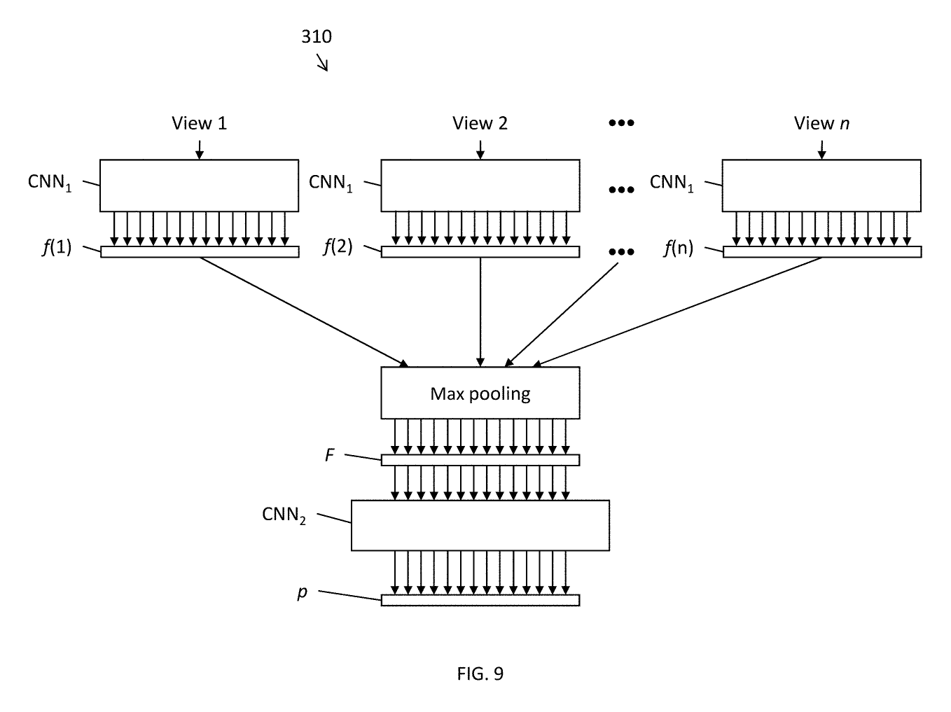

In embodiments or circumstances where geometric alignment is difficult to obtain (e.g., the iterative closest point technique would be too computationally expensive to perform), the defect detection system may use descriptors that have some degree of “pose invariance,” that do not change (or change minimally) when the pose of the objects they describe changes. For example, in the case of a multi-view representation of a shape as described earlier using with cameras placed on a sphere around the object, applying a max-pooling module can cause the resulting combined descriptor to be approximately invariant to a rotation of the object (see FIG. 9, described in more detail below).

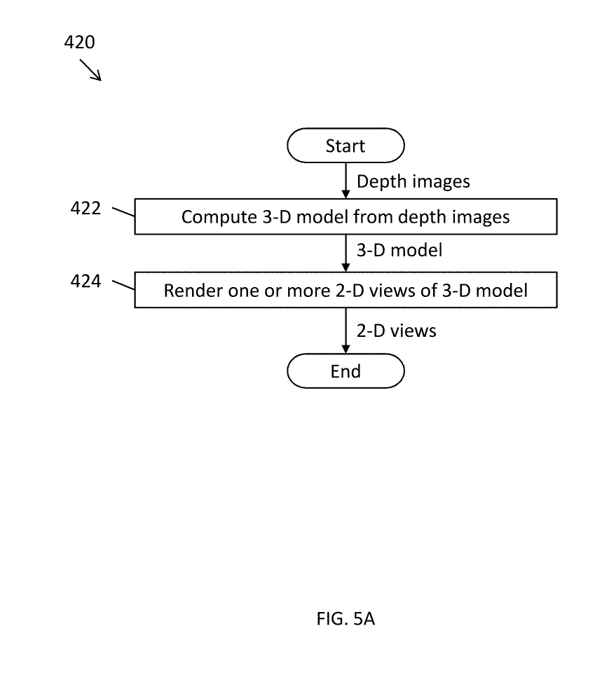

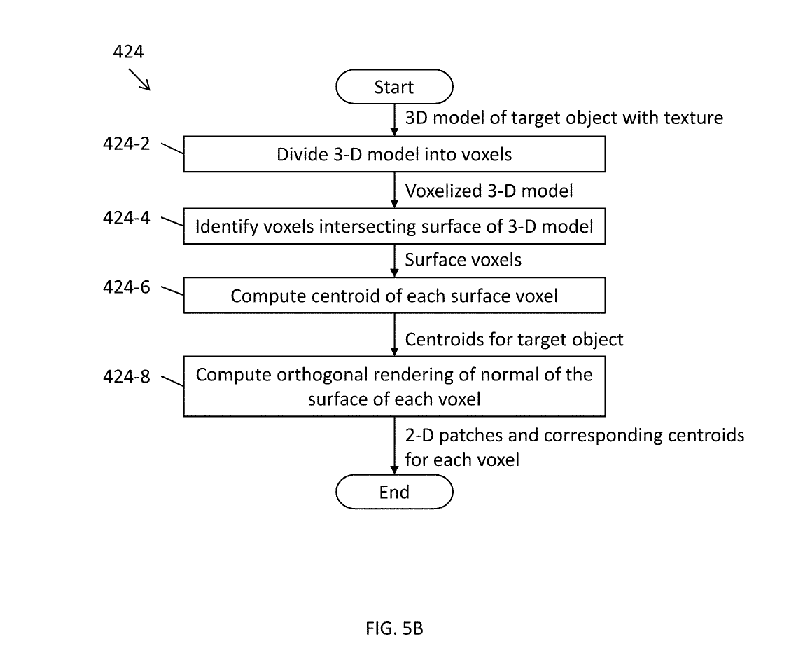

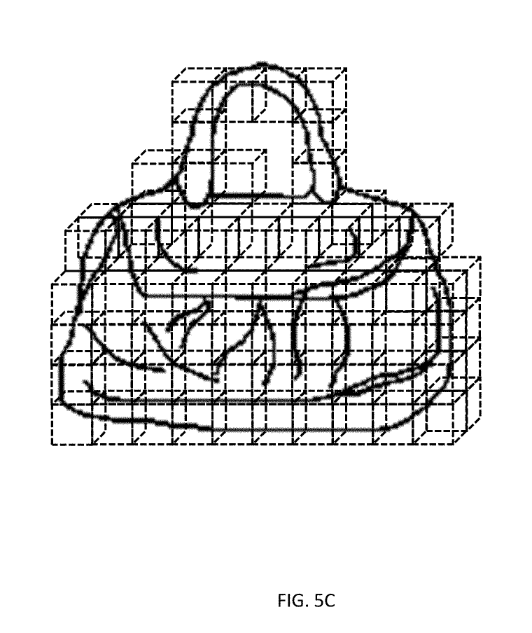

Accordingly, in some embodiments of the present invention, in operation 420, the shape to appearance converter 200 converts the captured depth images into a multi-view representation. FIG. 5A is a flowchart of a method for generating 2-D views of a target object according to one embodiment of the present invention. In particular, in some embodiments, the shape to appearance converter 200 synthesizes a 3-D model (or a 3-D mesh model) of the target object from the image data in operation 422 of FIG. 5A, and then renders 2-D views from the 3-D model in operation 424.

Generation of 3-D Models

If depth images 14 are captured at different poses (e.g., different locations with respect to the target object), then it is possible to acquire data regarding the shape of a larger portion of the surface of the target object than could be acquired by a single depth camera through a point cloud merging module 210 (see FIG. 3) that merges the separate point clouds 14 into a merged point cloud 220. For example, opposite surfaces of an object (e.g., the medial and lateral sides of the boot shown in FIG. 3) can both be acquired, whereas a single camera at a single pose could only acquire a depth image of one side of the target object at a time. The multiple depth images can be captured by moving a single depth camera over multiple different poses or by using multiple depth cameras located at different positions. Merging the depth images (or point clouds) requires additional computation and can be achieved using techniques such as an Iterative Closest Point (ICP) technique (see, e.g., Besl, Paul J., and Neil D. McKay. “Method for registration of 3-D shapes.” Robotics-DL tentative. International Society for Optics and Photonics, 1992.), which can automatically compute the relative poses of the depth cameras by optimizing (e.g., minimizing) a particular alignment metric. The ICP process can be accelerated by providing approximate initial relative poses of the cameras, which may be available if the cameras are “registered” (e.g., if the poses of the cameras are already known and substantially fixed in that their poses do not change between a calibration step and runtime operation). Systems and methods for capturing substantially all visible surfaces of an object are described, for example, in U.S. patent application Ser. No. 15/866,217, “Systems and Methods for Defect Detection,” filed in the United States Patent and Trademark Office on Jan. 9, 2018, the entire disclosure of which is incorporated by reference herein.

A point cloud, which may be obtained by merging multiple aligned individual point clouds (individual depth images) can be processed to remove “outlier” points due to erroneous measurements (e.g., measurement noise) or to remove structures that are not of interest, such as surfaces corresponding to background objects (e.g., by removing points having a depth greater than a particular threshold depth) and the surface (or “ground plane”) that the object is resting upon (e.g., by detecting a bottommost plane of points).

In some embodiments, the system further includes a plurality of color cameras 150 configured to capture texture data of the query object. The texture data may include the color, shading, and patterns on the surface of the object that are not present or evident in the physical shape of the object. In some circumstances, the materials of the target object may be reflective (e.g., glossy). As a result, texture information may be lost due to the presence of glare and the captured color information may include artifacts, such as the reflection of light sources within the scene. As such, some aspects of embodiments of the present invention are directed to the removal of glare in order to capture the actual color data of the surfaces. In some embodiments, this is achieved by imaging the same portion (or “patch”) of the surface of the target object from multiple poses, where the glare may only be visible from a small fraction of those poses. As a result, the actual color of the patch can be determined by computing a color vector associated with the patch for each of the color cameras, and computing a color vector having minimum magnitude from among the color vectors. This technique is described in more detail in U.S. patent application Ser. No. 15/679,075, “System and Method for Three-Dimensional Scanning and for Capturing a Bidirectional Reflectance Distribution Function,” filed in the United States Patent and Trademark Office on Aug. 15, 2017, the entire disclosure of which is incorporated by reference herein.

Returning to FIG. 3, in operation 424, the point clouds 14 are combined to generate a 3-D model. For example, in some embodiments, the separate point clouds 14 are merged by a point cloud merging module 210 to generate a merged point cloud 220 (e.g., by using ICP to align and merge the point clouds and also by removing extraneous or spurious points to reduce noise and to manage the size of the point cloud 3-D model) and a mesh generation module 230 computes a 3-D mesh 240 from the merged point cloud using techniques such as Delaunay triangulation and alpha shapes and software tools such as MeshLab (see, e.g., P. Cignoni, M. Callieri, M. Corsini, M. Dellepiane, F. Ganovelli, G. Ranzuglia MeshLab: an Open-Source Mesh Processing Tool Sixth Eurographics Italian Chapter Conference, pages 129-136, 2008.). The 3-D mesh 240 can be combined with color information 16 from the color cameras 150 about the color of the surface of the object at various points, and this color information may be applied to the 3-D mesh as a texture map (e.g., information about the color of the surface of the model).

Rendering 2-D Views

In operation 424, a view generation module 250 of the shape to appearance converter 200 renders particular two-dimensional (2-D) views 260 of the mesh model 240. In a manner similar to that described above, in some embodiments, the 3-D mesh model 240 may be used to render 2-D views of the surface of the entire object (e.g., a single image in which all parts of the object that are visible from a particular pose are contained in the single image) as viewed from multiple different viewpoints. In some embodiments, these 2-D views may be more amenable for use with existing neural network technologies, such as convolutional neural networks (CNNs), although embodiments of the present invention are not limited thereto.

In general, for any particular pose of a virtual camera with respect to the captured 3-D model, the system may compute the image that would be acquired by a real camera at the same pose relative to the target object, with the object lit by a specific virtual illumination source or illumination sources, and with specific assumptions about the reflectance characteristics of the object's surface elements. For example, one may assume that all points on the surface have purely diffuse reflectance characteristics (such as in the case of a Lambertian surface model, see, e.g., Horn, Berthold. Robot vision. MIT press, 1986.) with constant albedo (as noted above, as described in U.S. patent application Ser. No. 15/679,075, “System and Method for Three-Dimensional Scanning and for Capturing a Bidirectional Reflectance Distribution Function,” filed in the United States Patent and Trademark Office on Aug. 15, 2017, the entire disclosure of which is incorporated by reference herein, the texture of the 3-D model may be captured to obtain a Lambertian surface model). One particular example of a virtual illumination source is an isotropic point illumination source that is co-located with the optical center of the virtual camera, the value of the image synthesized at a pixel is proportional to the cosine of the angle between the normal vector of the surface at the point seen by that pixel and the associated viewing direction (this essentially generates an effect similar to a taking a photograph with an on-camera flash activated). However, embodiments of the present invention are not limited thereto. For example, some embodiments of the present invention may make use of a completely diffuse illumination with a uniform albedo surface; in this case, the image would only capture the silhouette of the object (see, e.g., Chen, D. Y., Tian, X. P., Shen, Y. T., & Ouhyoung, M. (2003, September). On visual similarity based 3-D model retrieval. In Computer graphics forum (Vol. 22, No. 3, pp. 223-232). Blackwell Publishing, Inc.). Rather than assuming uniform albedo, in some embodiments, each point of the surface is assigned an albedo value derived from actual color or grayscale images taken by standard cameras (e.g., two-dimensional color or grayscale cameras, as opposed to depth cameras), which may be geometrically registered with the depth cameras used to acquire the shape of the object. In this case, the image generated for a virtual camera is similar to the actual image of the object that would be obtained by a regular camera, under a chosen illumination. In some embodiments, a vector of values is encoded for each pixel. For example, the “HHA” representation encodes, at each pixel, the inverse of the distance to the surface element seen by the pixel; the height of the surface element above ground; and the angle formed by the normal vector at the surface element and the gravity direction (see, e.g., Gupta, S., Girshick, R., Arbeláez, P., & Malik, J. (2014, September). Learning rich features from RGB-D images for object detection and segmentation. In European Conference on Computer Vision (pp. 345-360). Springer International Publishing.).

To increase the representational power of this multi-view descriptor, in some embodiments of the present invention, multiple images from the same virtual camera can be rendered, where each rendering uses a different location of the point illumination source—increasing the angle formed by the surface normal and the incident light may enhance small surface details while at the same time casting different shadows. Furthermore, other spatial information can be included in the rendered images as supplementary “channels.” For example, for each virtual view, each pixel could contain a vector of data including the image value (e.g., the values of the individual color channels), the depth of the surface seen by the pixel, and its surface normal (e.g., a vector that is perpendicular to the surface at that point). These multi-channel images can then be fed to a standard CNN. Using a depth channel provides a descriptor extractor with additional information about the shape of the surface of the object that may not be readily detectable in the color image data. For example, shapes such as zippers and stitching may be more easily detected in a depth channel, and the depth of wrinkles and folds may be more easily measured in a depth channel.

Various embodiments of the present invention may use different sets of poses for the virtual cameras in the multi-view representation of an object as described above. A fine sampling (e.g., larger number of views) may lead to a higher fidelity of view-based representation, at the cost of a larger amount of data to be stored and processed. For example, the LightField Descriptor (LFD) model (see, e.g., Chen, D. Y., Tian, X. P., Shen, Y. T., & Ouhyoung, M. (2003, September). On visual similarity based 3-D model retrieval. In Computer graphics forum (Vol. 22, No. 3, pp. 223-232). Blackwell Publishing, Inc.) generates ten views from the vertices of a dodecahedron over a hemisphere surrounding the object, while the Compact Multi-View Descriptor (CMVD) model (see, e.g., Daras, P., & Axenopoulos, A. (2010). A 3-D shape retrieval framework supporting multimodal queries. International Journal of Computer Vision, 89(2-3), 229-247.) generates eighteen characteristic views from the vertices of a bounding icosidodecahedron. While a large number of views may sometimes be required to acquire a description of the full surface, in some situations this may be unnecessary, for instance when objects that are placed on a conveyor belt with a consistent pose. For example, in the case of scanning shoes in a factory, the shoes may be placed so that their soles always lie on the conveyor belt. In such an environment, a satisfactory representation of the visible surface of a shoe could be obtained from a small number of views. More specifically, the depth cameras 100 and the color cameras 150 may all be placed at the same height and oriented so that their optical axes intersect at the center of the shoe, and the virtual cameras may similarly be placed along a plane that is aligned with the center of the shoe. As such, while the shoe may be rotated to any angle with its sole on the conveyor belt, the virtual cameras can render consistent views of, for example, the medial and lateral sides of the shoe, the front of the shoe, and the heel of the shoe.

Rendering 2-D Views of Parts of an Object

In some embodiments of the present invention, the defect detection system performs parts-based surface analysis. While the surface of an object can be captured and analyzed in its entirety, as described above, in some circumstances, it is impractical to do so, such as for objects that are large or have complex shapes. Therefore, in these cases, in operation 424, some embodiments of the present invention render 2-D views of individual object “parts” (or “blocks” or “chunks”), or to select specific parts from an already captured surface (e.g., an existing scan of an object). Each of these chunks may be identified by a chunk identifier (or “chunk id”).

In some embodiments, the cameras 100 are arranged and configured to capture only a desired part of the object (e.g. using only one range camera or a set of range cameras), the camera be correctly positioned and aligned with the object, so that the same object part is captured each time. For example, in a factory making seats or chairs, a particular set of cameras may be configured to capture only images of an armrest, thereby allowing defect analysis of the armrest independently.

In some embodiments, if a larger portion of the object surface is acquired (e.g. by multiple calibrated cameras), then the surface portion corresponding to the desired part can be extracted from the acquired surface. In some embodiments, this is performed by precisely defining the location of the part and its boundaries on a reference model, then using this geometric information to isolate points on the newly acquired shape, after aligning the acquired shape with the reference model. In another embodiment of the present invention, a trained a machine learning system (e.g., a three-dimensional CNN) can be used to identify a specific part on the acquired 3-D shape.

Rendering 2-D Views of Patches of an Object

In some embodiments of the present invention, the shape to appearance converter renders 2-D views of individual patches of the surface of the object. FIG. 5B is a flowchart of a method for rendering 2-D views of patches of an object according to one embodiment of the present invention. FIG. 5C is a schematic depiction of the surface voxels of a 3-D model of a handbag.

Referring to FIG. 5B, in operation 424-2, the view generation module 250 divides the 3-D model into a plurality of voxels (e.g., three-dimensional boxes of the same size), where at least some portion of the 3-D model intersects with each voxel. The sizes of the voxels may be set based on the size of the features to be detected in the target object. For example, in the case of a shoe, a stitching defect may be identifiable in a 3 cm by 3 cm block, whereas a defective wrinkle may be 7 cm by 10 cm wide. Accordingly, in various embodiments of the present invention, the voxels are sized to be sufficiently large to capture the desired defects, while being small enough to localize the defects and to be processed quickly. In some embodiments of the present invention, multiple resolutions of voxels are used. FIG. 5C schematically depicts a collection of non-overlapping surface voxels of a 3-D model of a handbag. However, embodiments of the present invention are not limited to non-overlapping voxels. For example, in some embodiments of the present invention, adjacent voxels overlap.

In operation 424-4, the view generation module 250 identifies surface voxels from among the voxels, where the surface voxels intersect with the surface of the 3-D model. (In some instances, operations 424-2 and 424-4 may be combined, in that the 3-D model itself may be represented as a shell and all of the voxels identified in operation 424-2 are already surface voxels). In operation 424-6, the view generation module 250 computes the centroid of each surface voxel. In operation 424-8, the view generation module 250 computes an orthogonal rendering of the normal of the surface of each voxel. For example, in one embodiment, for each surface voxel, the view generation module 250 places a virtual camera oriented with its optical axis along the average normal direction of the surface of the object contained in the surface voxel and renders an image of the surface patch from that direction.

In some embodiments of the present invention, the rendering of individual patches is applied on a part or chunk of an object isolated from the rest of an object, as described above in the section “Rendering 2-D views of parts of an object.” Each of the patches may be associated with both the coordinates of its centroid and the chunk id of the chunk that the surface patch came from.

In some embodiments of the present invention, the view generation module 250 renders multiple views of the patch under different illumination conditions in a manner substantially similar to that described above with respect to the multi-view rendering.

The result of this operation is rendering of 2-D views of patches of an object, where each patch corresponds to one surface voxel of the object, along with the locations of the centroids of each voxel and the location of the voxel within the 3-D model of the object.

Therefore, in various embodiments of the present invention, the shape to appearance converter 200 generates one or more types of views of the object from the captured depth data of the object. These types of views include multi-views of the entire object, multi-views of parts of the object, patches of the entire object, and patches of parts of the object.

Defect Detection

Aspects of embodiments of the present invention include two general categories of defects that may occur in manufactured objects. The first category includes defects that can be detected by analyzing the appearance of the surface, without metric (e.g., numeric) specifications. More precisely, these defects are such that they can be directly detected on the basis of a learned descriptor vector. These may include, for example: the presence of wrinkles, puckers, bumps or dents on a surface that is expected to be flat; two joining parts that are out of alignment; the presence of a gap where two surfaces are supposed to be touching each other. These defects can be reliably detected by a system trained (e.g., a trained neural network) with enough examples of defective and non-defective units.

The second category of defects includes defects that are defined based on a specific measurement of a characteristic of the object or of its surfaces, such as the maximum width of a zipper line, the maximum number of wrinkles in a portion of the surface, or the length or width tolerance for a part.

In various embodiments of the present invention, these two categories are addressed using different technological approaches, as discussed in more detail below. It should be clear that the boundary between these two categories is not well defined, and some types of defects can be detected by both systems (and thus could be detected with either one of the systems described in the following).

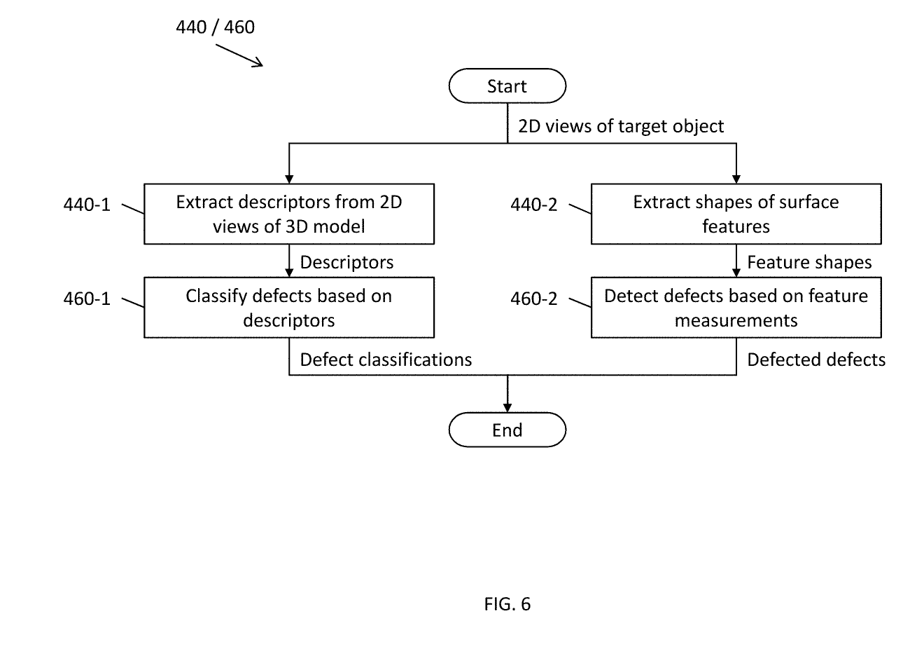

Accordingly, FIG. 6 is a flowchart illustrating a descriptor extraction stage 440 and a defect detection stage 460 according to one embodiment of the present invention. In particular, the 2-D views of the target object that were generated by the shape to appearance converter 200 can be supplied to detect defects using the first category techniques of extracting descriptors from the 2-D views of the 3-D model in operation 440-1 and classifying defects based on the descriptors in operation 460-1 or using the second category techniques of extracting the shapes of regions corresponding to surface features in operation 440-2 and detecting defects based on measurements of the shapes of the features in operation 460-2.

Category 1 Defect Detection

Defects in category 1 can be detected using a trained classifier that takes in as input the 2-D views of the 3-D model of a surface or of a surface part, and produces a binary output indicating the presence of a defect. In some embodiments of the present invention, the classifier produces a vector of numbers, where each number corresponds to a different possible defect class and the number represents, for example, the posterior probability distribution that the input data contains an instance of the corresponding defect class. In some embodiments, this classifier is implemented as the cascade of a convolutional network (e.g., a network of convolutional layers) and of a fully connected network, applied to a multi-view representation of the surface. Note that this is just one possible implementation; other types of statistical classifiers could be employed for this task.

FIG. 7 is a block diagram of a convolutional neural network 310 according to one embodiment of the present invention. According to some embodiments of the present invention, a convolutional neural network (CNN) is used to process the synthesized 2-D views 16 to generate the defect classification of the object. Generally, a deep CNN processes an image by passing the input image data (e.g., a synthesized 2-D view) through a cascade of layers. These layers can be grouped into multiple stages. The deep convolutional neural network shown in FIG. 7 includes two stages, a first stage CNN₁ made up of N layers (or sub-processes) and a second stage CNN₂ made up of M layers. In one embodiment, each of the N layers of the first stage CNN1 includes a bank of linear convolution layers, followed by a point non-linearity layer and a non-linear data reduction layer. In contrast, each of the M layers of the second stage CNN2 is a fully connected layer. The output p of the second stage is a class-assignment probability distribution. For example, if the CNN is trained to assign input images to one of k different classes, then the output of the second stage CNN₂ is an output vector p that includes k different values, each value representing the probability (or “confidence”) that the input image should be assigned the corresponding defect class (e.g., containing a tear, a wrinkle, discoloration or marring of fabric, missing component, etc.).

The computational module that produces a descriptor vector from a 3-D surface is characterized by a number of parameters. In this case, the parameters may include the number of layers in the first stage CNN₁ and the second stage CNN₂, the coefficients of the filters, etc. Proper parameter assignment helps to produce a descriptor vector that can effectively characterize the relevant and discriminative features enabling accurate defect detection. A machine learning system such as a CNN “learns” some of these parameters from the analysis of properly labeled input “training” data.

The parameters of the system are typically learned by processing a large number of input data vectors, where the real (“ground truth”) class label of each input data vector is known. For example, the system could be presented with a number of 3-D scans of non-defective items, as well as of defective items. The system could also be informed of which 3-D scan corresponds to a defective or non-defective item, and possibly of the defect type. Optionally, the system could be provided with the location of a defect. For example, given a 3-D point cloud representation of the object surface, the points corresponding to a defective area can be marked with an appropriate label. The supplied 3-D training data may be processed by the shape to appearance converter 250 to generate 2-D views (in some embodiments, with depth channels) to be supplied as input to train one or more convolutional neural networks 310.

Training a classifier generally involves the use of enough labeled training data for all considered classes. For example, the training set for training a defect detection system according to some embodiments of the present invention contains a large number of non-defective items as well as a large number of defective items for each one of the considered defect classes. If too few samples are presented to the system, the classifier may learn the appearance of the specific samples, but might not correctly generalize to samples that look different from the training samples (a phenomenon called “overfitting”). In other words, during training, the classifier needs to observe enough samples for it to form an internal model of the general appearance of all samples in each class, rather than just the specific appearance of the samples used for training.

The parameters of the neural network (e.g., the weights of the connections between the layers) can be learned from the training data using standard processes for training neural network such as backpropagation and gradient descent (see, e.g., LeCun, Y., & Bengio, Y. (1995). Convolutional networks for images, speech, and time series. The handbook of brain theory and neural networks, 3361(10), 1995.). In addition, the training process may be initialized using parameters from a pre-trained general-purpose image classification neural network (see, e.g., Chatfield, K., Simonyan, K., Vedaldi, A., & Zisserman, A. (2014). Return of the devil in the details: Delving deep into convolutional nets. arXiv preprint arXiv: 1405.3531.).

In order to train the system, one also needs to define a “cost” function that assigns, for each input training data vector, a number that depends on the output produced by the system and the “ground truth” class label of the input data vector. The cost function should penalize incorrect results produced by the system. Appropriate techniques (e.g., stochastic gradient descent) can be used to optimize the parameters of the network over the whole training data set, by minimizing a cumulative value encompassing all individual costs. Note that changing the cost function results in a different set of network parameters.

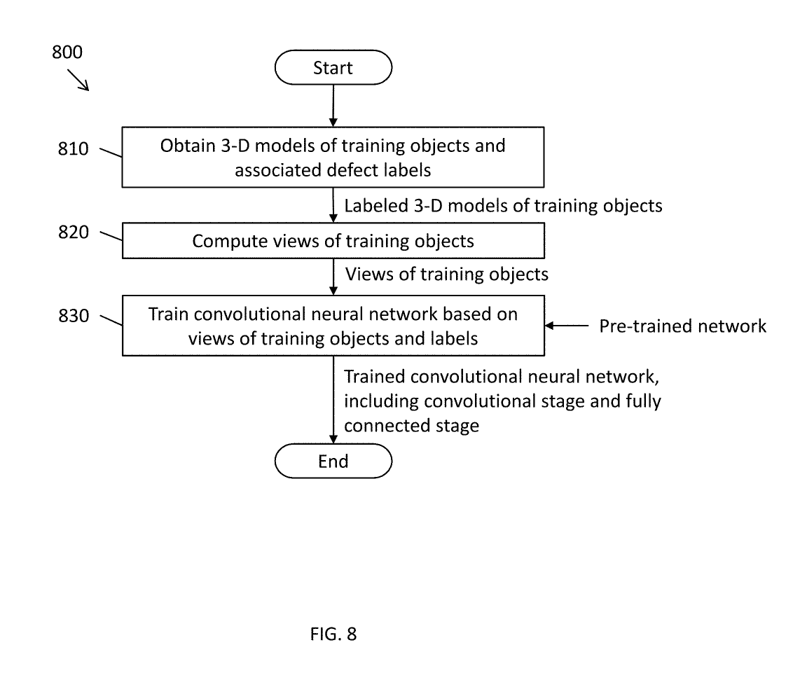

FIG. 8 is a flowchart of a method for training a convolutional neural network according to one embodiment of the present invention. In operation 810, the training system 20 obtains three-dimensional models of the training objects and corresponding labels. This may include, for example, receiving 3-D scans of actual defective and non-defective objects from the intended environment in which the defect detection system will be applied. The corresponding defect labels may be manually entered by a human using, for example, a graphical user interface, to indicate which parts of the 3-D models of the training objects correspond to defects, as well as the class or classification of the defect (e.g., a tear, a wrinkle, too many folds, and the like), where the number of classes may correspond to the length k of the output vector p. In operation 820, the training system 20 uses the shape to appearance converter 200 to convert the received 3-D models 14d and 14c of the training objects into views 16d and 16c of the training objects. The labels of defects may also be transformed during this operation to continue to refer to particular portions of the views 16d and 16c of the training objects. For example, a tear in the fabric of a defective training object may be labeled in the 3-D model as a portion of the surface of the 3-D model. This tear is similarly labeled in the generated views of the defective object that depict the tear (and the tear would not be labeled in generated views of the defective object that do not depict the tear).

In operation 830, the training system 20 trains a convolutional neural network based on the views and the labels. In some embodiments, a pre-trained network or pre-training parameters may be supplied as a starting point for the network (e.g., rather than beginning the training from a convolutional neural network configured with a set of random weights). As a result of the training process in operation 830, the training system 20 produces a trained neural network 310, which may have a convolutional stage CNN₁ and a fully connected stage CNN₂, as shown in FIG. 7. As noted above, each of the k entries of the output vector p represents the probability that the input image exhibits the corresponding one of the k classes of defects.

As noted above, embodiments of the present invention may be implemented on suitable general purpose computing platforms, such as general purpose computer processors and application specific computer processors. For example, graphical processing units (GPUs) and other vector processors (e.g., single instruction multiple data or SIMD instruction sets of general purpose processors or a Google® Tensor Processing Unit (TPU)) are often well suited to performing the training and operation of neural networks.

Training a CNN is a time-consuming operation, and requires a vast amount of training data. It is common practice to start from a CNN previously trained on a (typically large) data set (pre-training), then re-train it using a different (typically smaller) set with data sampled from the specific application of interest, where the re-training starts from the parameter vector obtained in the prior optimization (this operation is called fine-tuning Chatfield, K., Simonyan, K., Vedaldi, A., & Zisserman, A. (2014). Return of the devil in the details: Delving deep into convolutional nets. arXiv preprint arXiv: 1405.3531.). The data set used for pre-training and for fine-tuning may be labeled using the same object taxonomy, or even using different object taxonomies (transfer learning).

Accordingly, the parts based approach and patch based approach described above can reduce the training time by reducing the number of possible classes that need to be detected. For example, in the case of a car seat, the types of defects that may appear on the front side of a seat back may be significantly different from the defects that are to be detected on the back side of the seat back. In particular, the back side of a seat back may be a mostly smooth surface of a single material, and therefore the types of defects may be limited to tears, wrinkles, and scuff marks on the material. On the other hand, the front side of a seat back may include complex stitching and different materials than the seat back, which results in particular expected contours. Because the types of defects found the front side and back side of a seat back are different, it is generally easier to train two separate convolutional neural networks for detecting a smaller number of defect classes (e.g., k_{back} and k_{front}) than to train a single convolutional neural network for detecting the sum of those numbers of defect classes (e.g., k_{back}+k_{front}). Accordingly, in some embodiments, different convolutional neural networks 310 are trained to detect defects in different parts of the object, and, in some embodiments, different convolutional neural networks 310 are trained to detect different classes or types of defects. These embodiments allow the resulting convolutional neural networks to be fine-tuned to detect particular types of defects and/or to detect defects in particular parts.

Therefore, in some embodiments of the present invention, a separate convolutional neural network 310 is trained for each part of the object to be analyzed. In some embodiments, a separate convolutional neural network 310 may also be trained each separate defect to be detected.

As shown in FIG. 7, the values computed by the first stage CNN₁ (the convolutional stage) and supplied to the second stage CNN₂ (the fully connected stage) are referred to herein as a descriptor (or feature vector) f. The descriptor may be a vector of data having a fixed size (e.g., 4,096 entries) which condenses or summarizes the main characteristics of the input image. As such, the first stage CNN₁ may be used as a feature extraction stage of the defect detector 300.

In some embodiments the views may be supplied to the first stage CNN₁ directly, such as in the case of single rendered patches of the 3-D model or single views of a side of the object. FIG. 9 is a schematic diagram of a max-pooling neural network according to one embodiment of the present invention. As shown in FIG. 9, the architecture of a classifier 310 described above with respect to FIG. 7 can be applied to classifying multi-view shape representations of 3-D objects based on n different 2-D views of the object. These n different 2-D views may include circumstances where the virtual camera is moved to different poses with respect to the 3-D model of the target object, circumstances where the pose of the virtual camera and the 3-D model is kept constant and the virtual illumination source is modified (e.g., location), and combinations thereof (e.g., where the rendering is performed multiple times with different illumination for each camera pose).

For example, the first stage CNN₁ can be applied independently to each of the n 2-D views used to represent the 3-D shape, thereby computing a set of n feature vectors f(1), f(2), . . . , f(n) (one for each of the 2-D views). In the max pooling stage, a pooled vector F is generated from the n feature vectors, where the i-th entry Fᵢ of the pooled feature vector is equal to the maximum of the i-th entries of the n feature vectors (e.g,. Fᵢ=max(fᵢ(1), fᵢ(2), . . . , fᵢ(n)) for all indices i in the length of the feature vector, such as for entries 1 through 4,096 in the example above). Aspects of this technique are described in more detail in, for example, Su, H., Maji, S., Kalogerakis, E., & Learned-Miller, E. (2015). Multi-view convolutional neural networks for 3-D shape recognition. In Proceedings of the IEEE International Conference on Computer Vision (pp. 945-953). In some embodiments, the n separate feature vectors are combined using, for example, max pooling (see, e.g., Boureau, Y. L., Ponce, J., & LeCun, Y. (2010). A theoretical analysis of feature pooling in visual recognition. In Proceedings of the 27th international conference on machine learning (ICML-10) (pp. 111-118).).

Some aspects of embodiments of the present invention are directed to the use of max-pooling to mitigate some of the pose invariance issues described above. In some embodiments of the present invention, the selection of particular poses of the virtual cameras, e.g., the selection of which particular 2-D views to render, results in a descriptor F having properties that are invariant. For example, considering a configuration where all the virtual cameras are located on a sphere (e.g., all arranged at poses that are at the same distance from the center of the 3-D model or a particular point p on the ground plane, and all having optical axes that intersect at the center of the 3-D model or at the particular point p on the ground plane). Another example of an arrangement with similar properties includes all of the virtual cameras located at the same elevation above the ground plane of the 3-D model, oriented toward the 3-D model (e.g., having optical axes intersecting with the center of the 3-D model), and at the same distance from the 3-D model, in which case any rotation of the object around a vertical axis (e.g., perpendicular to the ground plane) extending through the center of the 3-D model will result in essentially the same vector or descriptor F (assuming that the cameras are placed at closely spaced locations).

Training Set Size

In some situations, it is difficult or prohibitively expensive to access a large number of samples. For example, the occurrence of a particular defect may be rare, and therefore non-defective samples are readily available, but only few samples have that particular defect.

Augmenting Training Set

In some embodiments of the present invention, the size of the training set is increased by synthetically generating samples of defective surfaces from a probability distribution that is assumed to represent the variability of surfaces affected by that defect. This data augmentation approach is described, for example, in Krizhevsky, A., Sutskever, I., & Hinton, G. E. (2012). Imagenet classification with deep convolutional neural networks. In Advances in neural information processing systems (pp. 1097-1105). If enough samples can be generated with realistic characteristics, the classifier can be trained with reduced risk of overfitting.

As a specific example, consider a system designed to detect the presence of a certain wrinkle pattern in the bolster panel of car seats. Suppose that wrinkles may appear anywhere along the edge of the panel, but that only one sample seat with this type of defect is available for training the system. In some embodiments, a 3-D model of this surface is acquired, and the location of the wrinkles can be manually identified on this surface model. Using appropriate 3-D model editing software, similar wrinkles can be replicated in other places along the edge of the panel, while at the same time removing the original wrinkles. Furthermore, the size and shape of the wrinkles may be modified (in accordance with the expected distribution of shapes and sizes of wrinkles.) The model thus obtained may represent an additional synthetic defective sample that can be used for training the classifier.

As hinted in this example, data augmentation is only feasible when a method is available to generate samples that realistically represent the variability of appearance for a certain class of defects. While in some cases a simple perturbation of the surface may suffice, in other cases it may be necessary to create a physical model of the object and of its components, including parameters of its materials such as Young's modulus, bending stiffness, and tensile strength. This physical model could, for example, be built starting from a CAD model of the object. Using this model, it may be possible to generate deformations that are consistent with the physical structure of the object. As another example, in the case of the junction of two parts, one could model each part independently, then generate synthetic defects by changing the gap and/or alignment between the two parts within realistic limits. In this case, the designer of the training set may identify the different object parts within the 3-D acquired surface and move them so as to generate gaps within a realistic range of widths.

A second method for dealing with limited access to defective examples will be described in more detail below in the section “Performing defect detection by computing distances between descriptors.”

Performing Defect Detection using the Trained CNN

Given a trained convolutional neural network, including convolutional stage CNN₁ and fully connected stage CNN₂, in some embodiments, the views of the target object computed in operation 420 are supplied to the convolutional stage CNN₁ of the convolutional neural network 310 in operation 440-1 to compute descriptors f or pooled descriptors F. The views may be among the various types of views described above, including single views or multi-views of the entire object, single views or multi-views of a separate part of the object, and single views or multi-views (e.g., with different illumination) of single patches. The resulting descriptors are then supplied in operation 460-1 as input to the fully connected stage CNN₂ to generate one or more defect classifications (e.g., using the fully connected stage CNN₂ in a forward propagation mode). The resulting output is a set of defect classes.

As discussed above, multiple convolutional neural networks 310 may be trained to detect different types of defects and/or to detect defects in particular parts (or segments) of the entire object. Therefore, all of these convolutional neural networks 310 may be used when computing descriptors and detecting defects in the captured image data of the target object.

In some embodiments of the present invention in which the input images are defined in segments, it is useful to apply a convolutional neural network that can classify a defect and identify the location of the defect in the input in one shot. Because the network accepts and processes a rather large and semantically identifiable segment of an object under test, it can reason globally for that segment and preserve the contextual information about the defect. For instance, if a wrinkle appears symmetrically in a segment of a product, that may be considered acceptable, whereas if the same shape wrinkle appeared on only one side of the segment under test, it should be flagged as defect. Examples of convolutional neural networks that can classify a defect and identify the location of the defect in the input in one shot as described in, for example, Redmon, Joseph, et al. “You only look once: Unified, real-time object detection.” Proceedings of the IEEE conference on computer vision and pattern recognition. 2016. and Liu, Wei, et al. “SSD: Single shot multibox detector.” European conference on computer vision. Springer, Cham, 2016.

Computing Distances Between Descriptors

Another approach to defect detection in the face of limited access to defective examples for training is to declare as “defective” an object that, under an appropriate metric, has appearance that is substantially different from a properly aligned non-defective model object. Therefore, in some embodiments of the present invention, in operation 460-1, the discrepancy between a target object and a reference object surface is measured by the distance between their descriptors f or F (the descriptors computed in operation 440-1 as described above with respect to the outputs of the first stage CNN₁ of the convolutional neural network 310). Descriptor vectors represent a succinct description of the relevant content of the surface. If the distance of the descriptor vectors of a model to the descriptor vector of the sample surface exceeds a threshold, then the unit can be deemed to be defective. This approach is very simple and can be considered an instance of “one-class classifier” (see, e.g., Manevitz, L. M., & Yousef, M. (2001). One-class SVMs for document classification. Journal of Machine Learning Research, 2(December), 139-154.).

In some embodiments, a similarity metric is defined to measure the distance between any two given descriptors (vectors) F and F_{ds}(m). Some simple examples of similarity metrics are a Euclidean vector distance and a Mahalanobis vector distance. In other embodiments of the present invention a similarity metric is learned using a metric learning algorithm (see, e.g., Boureau, Y. L., Ponce, J., & LeCun, Y. (2010). A theoretical analysis of feature pooling in visual recognition. In Proceedings of the 27th international conference on machine learning (ICML-10) (pp. 111-118).). A metric learning algorithm may learn a linear or non-linear transformation of feature vector space that minimizes the average distance between vector pairs belonging to the same class (as measured from examples in the training data) and maximizes the average distance between vector pairs belonging to different classes.

In some cases, non-defective samples of the same object model may have different appearances. For example, in the case of a leather handbag, non-defective folds on the leather surface may occur at different locations. Therefore, in some embodiments, multiple representative non-defective units are acquired and their corresponding descriptors are stored. When performing the defect detection operation 460-1 on a target object, the defect detection module 370 computes distances between the descriptor of the target unit and the descriptors of each of the stored non-defective units. In some embodiments, the smallest such distance is used to decide whether the target object is defective or not, where the target object is determined to be non-defective if the distance is less than a threshold distance and determined to be defective if the distance is greater than the threshold distance.

A similar approach can be used to take any available defective samples into consideration. The ability to access multiple defective samples allows the defect detection system to better determine whether a new sample should be considered defective or not. Given the available set of non-defective and of defective part surfaces (as represented via their descriptors), in some embodiments, the defect detection module 370 computes the distance between the descriptor of the target object under consideration and the descriptor of each such non-defective and defective samples. The defect detection module 370 uses the resulting set of distances to determine the presence of a defect. For example, in some embodiments, the defect detection module 370 determines in operation 460-1 that the target object is non-defective if its descriptor is closest to that of a non-defective sample, and determines the target object to exhibit a particular defect if its descriptor is closest to a sample with the same defect type. This can be considered as an instance of a nearest neighbor classifier Bishop, C. M. (2006). Pattern recognition and Machine Learning, 128, 1-58. Possible variations of this method include a k-nearest neighbor strategy, whereby the k closest neighbors (in descriptor space) in the cumulative set of stored samples are computed for a reasonable value of k (e.g., k=3). The target object is then labeled as defective or non-defective depending on the number of defective and non-defective samples in the set of k closest neighbors. It is also important to note that, from the descriptor distance of a target object and the closest sample (or samples) in the data set, it is possible to derive a measure of “confidence” of classification. For example, classification of a target object whose descriptor has comparable distance to the closest non-defective and to the closest defective samples in the data set could be considered to be difficult to classify, and thus receive a low confidence score. On the other hand, if a unit is very close in descriptor space to a non-defective sample, and far from any available defective sample, it could be classified as non-defective with high confidence score.

The quality of the resulting classification depends on the ability of the descriptors (computed as described above) to convey discriminative information about the surfaces. In some embodiments, the network used to compute the descriptors is tuned based on the available samples. This can be achieved, for example, using a “Siamese network” trained with a contrastive loss (see, e.g., Chopra, S., Hadsell, R., and LeCun, Y. (2005, June). Learning a similarity metric discriminatively, with application to face verification. In Computer Vision and Pattern Recognition, 2005. CVPR 2005. IEEE Computer Society Conference on (Vol. 1, pp. 539-546). IEEE.) Contrastive loss encourages descriptors of objects within the same class (defective or non-defective) to have small Euclidean distance, and penalizes descriptors of objects from different classes with similar Euclidean distance. A similar effect can be obtained using known methods of “metric learning” (see, e.g., Weinberger, K. Q., Blitzer, J., & Saul, L. (2006). Distance metric learning for large margin nearest neighbor classification. Advances in neural information processing systems, 18, 1473.).

According to some embodiment of the present invention, an “anomaly detection” approach may be used to detect defects. Such approaches may be useful when defects are relatively rare and most of the training data corresponds to a wide range of non-defective samples. According to one embodiment of the present invention, descriptors are computed for every sample of the training data of non-defective samples. Assuming that each entry of the descriptors falls within a normal (or Gaussian) distribution and that all of the non-defective samples lies within some distance (e.g., two standard deviations) of the mean of the distribution, descriptors that fall outside of the distance are considered to be anomalous or defective.

Category 2 Defect Detection

In some embodiments, category 2 defects are detected through a two-step process. Referring to FIG. 6, the first step 440-2 includes the automatic identification of specific “features” in the surface of the target object. For example, for a leather bag, features of interest could be the seams connecting two panels, or each individual leather fold. For a car seat, features of interest could include a zipper line, a wrinkle on a leather panel, or a noticeable pucker at a seam. These features are not, by themselves, indicative of a defect. Instead, the presence of a defect can be inferred from specific spatial measurements of the detected features, as performed in operation 460-2. For example, the manufacturer may determine that a unit is defective if it has more than, say, five wrinkles on a side panel, or if a zipper line deviates by more than 1 cm from a straight line. These types of measurements can be performed once the features have been segmented out of the captured image data (e.g., depth images) in operation 440-2.

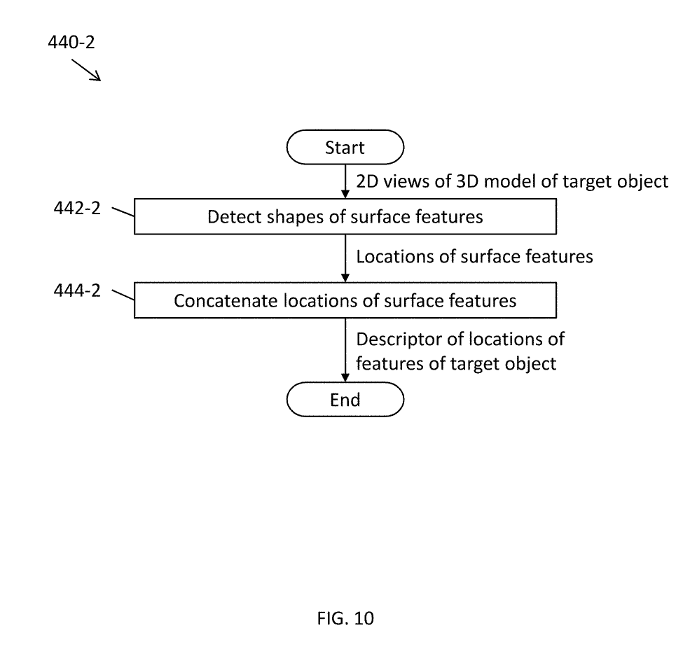

FIG. 10 is a flowchart of a method for generating descriptors of locations of features of a target object according to one embodiment of the present invention. In some embodiments of the present invention, feature detection and segmentation of operation 440-2 is performed using a convolutional neural network 310 that is trained to identify the locations of labeled surface features (e.g., wrinkles, zipper lines, and folds) in operation 442-2. According to some embodiments of the present invention, a feature detecting convolutional neural network is trained using a large number of samples containing the features of interest, where these features have been correctly labeled (e.g., by hand). In some circumstances, this means that each surface element (e.g., points in the acquired point cloud, or triangular facets in a mesh) are assigned a tag indicating whether they correspond to a feature, and if so, an identifier (ID) corresponding to the feature. Hand labeling of a surface can be accomplished using software with a suitable user interface. In some embodiments, in operation 444-2, the locations of the surface features are combined (e.g., concatenated) to form a descriptor of the locations of the features of the target object. The feature detecting convolutional neural network is trained to label the regions of the two-dimensions that correspond to particular trained features of the surface of the 3-D model (e.g., seams, wrinkles, stiches, patches, tears, folds, and the like).

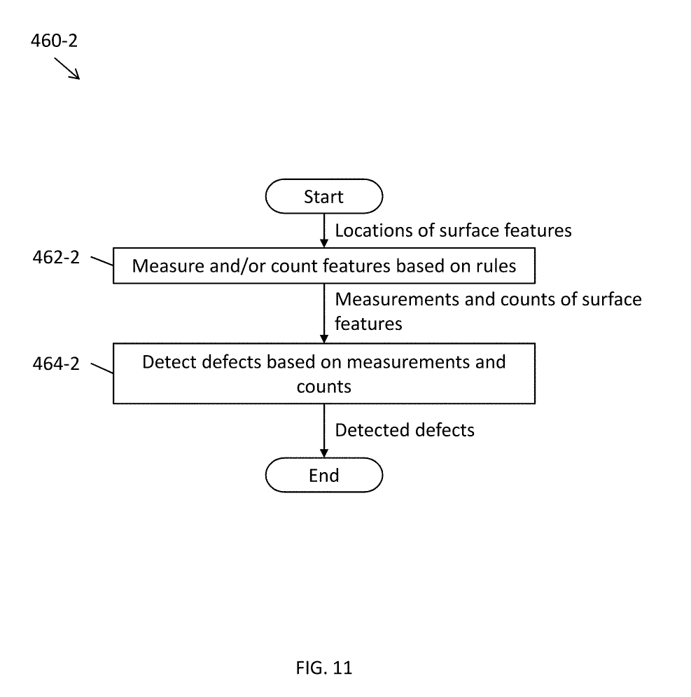

FIG. 11 is a flowchart of a method for detecting defects based on descriptors of locations of features of a target object according to one embodiment of the present invention. In some embodiments of the present invention, explicit rules may be supplied by the user for determining, in operation 460-2, whether a particular defect exists in the target object by measuring and/or counting, in operation 462-2, the locations of the features identified in operation 440-2. As noted above, in some embodiments, defects are detected in operation 464-2 by comparing the measurements and/or counts with threshold levels, such as by counting the number of wrinkles detected in a part (e.g., a side panel) and comparing the counted number to a threshold number of wrinkles that are within tolerance thresholds. When the defect detection system 370 determines that the counting and/or measurement is within the tolerance thresholds, then the object (or part thereof) is labeled as being non-defective, and when the counting and/or measurement is outside of a tolerance threshold, then the defect detection system 370 labels the object (or part thereof) as being defective (e.g., assigns a defect classification corresponding to the measurement or count). The measurements may also relate to the size of objects (e.g., the length of stitching) and ensuring that the measured stitching is within an expected range (e.g., about 5 cm). The depth measurements may also be used to perform measurements. For example, wrinkles having a depth greater than 0.5 mm may be determined to indicate a defect while wrinkles having a smaller depth may be determined to be non-defective.

Referring back to FIG. 6, the defects detected through the category 1 process of operations 440-1 and 460-1 and the defects detected through the category 2 process of operations 440-2 and 460-2 can be combined and displayed to a user, e.g., on a display panel of a user interface device (e.g., a tablet computer, a desktop computer, or other terminal) to highlight the locations of defects (see, e.g. FIGS. 1B, 1C, and 1D). In addition, as noted above, some in some embodiments of the present invention, the detection of defects is used to automatically control a conveyor system to direct defective and non-defective objects (e.g., sort objects) based on the types of defects found and/or the absence of defects.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method for detecting defects in objects comprising:
controlling, by a processor, one or more depth cameras to capture a plurality of depth images of a target object;
computing, by the processor, a three-dimensional (3-D) model of the target object using the depth images;
rendering, by the processor, one or more views of the 3-D model;
computing, by the processor, a descriptor by supplying the one or more views of the 3-D model to a convolutional stage of a convolutional neural network;
supplying, by the processor, the descriptor to a defect detector to compute one or more defect classifications of the target object; and
outputting the one or more defect classifications of the target object.

2. The method of claim 1, further comprising controlling a conveyor system to direct the target object is accordance with the one or more defect classifications of the target object.

3. The method of claim 1, further comprising displaying the one or more defect classifications of the target object on a display device.

4. The method of claim 1, wherein the defect detector comprises a fully connected stage of the convolutional neural network.

5. The method of claim 1, wherein the convolutional neural network is trained based on an inventory comprising:
a plurality of 3-D models of a plurality of defective objects, each 3-D model of the defective objects having a corresponding defect classification; and
a plurality of 3-D models of a plurality of non-defective objects.

6. The method of claim 5, wherein each of the defective objects and non-defective objects of the inventory is associated with a corresponding descriptor, and
wherein the classifier is configured to compute the classification of the target object by:
outputting the classification associated with a corresponding descriptor of the corresponding descriptors having a closest distance to the descriptor of the target object.

7. The method of claim 1, wherein the one or more views comprise a plurality of views, and
wherein the computing the descriptor comprises:
supplying each view of the plurality of views to the convolutional stage of the convolutional neural network to generate a plurality of single view descriptors; and
supplying the plurality of single view descriptors to a max pooling stage to generate the descriptor from the maximum values of the single view descriptors.

8. The method of claim 1, wherein the computing the descriptor comprises:
supplying the one or more views of the 3-D model to a feature detecting convolutional neural network to identify shapes of one or more features of the 3-D model.

9. The method of claim 8, wherein the defect detector is configured to compute at least one of the one or more defect classifications of the target object by:
counting or measuring the shapes of the one or more features of the 3-D model to generate at least one count or at least one measurement;
comparing the at least one count or at least one measurement to a tolerance threshold; and
determining the at least one of the one or more defect classifications as being present in the target object in response to determining that the at least one count or at least one measurement is outside the tolerance threshold.

10. The method of claim 1, wherein the 3-D model comprises a 3-D mesh model computed from the depth images.

11. The method of claim 1, wherein the rendering the one or more views of the 3-D model comprises:
rendering multiple views of the entire three-dimensional model from multiple different virtual camera poses relative to the three-dimensional model.

12. The method of claim 1, wherein the rendering the one or more views of the 3-D model comprises:
rendering multiple views of a part of the three-dimensional model.

13. The method of claim 1, wherein the rendering the one or more views of the 3-D model comprises:
dividing the 3-D model into a plurality of voxels;
identifying a plurality of surface voxels of the 3-D model by identifying voxels that intersect with a surface of the 3-D model;
computing a centroid of each surface voxel; and
computing orthogonal renderings of the normal of the surface of the 3-D model in each of the surface voxels, and
wherein the one or more views of the 3-D model comprises the orthogonal renderings.

14. The method of claim 1, wherein each of the one or more views of the 3-D model comprises a depth channel.

15. A system for detecting defects in objects comprising:
one or more depth cameras configured to capture a plurality of depth images of a target object;
a processor configured to control the one or more depth cameras;
a memory storing instructions that, when executed by the processor, cause the processor to:
control the one or more depth cameras to capture the plurality of depth images of the target object;
compute a three-dimensional (3-D) model of the target object using the depth images;
render one or more views of the 3-D model;
compute a descriptor by supplying the one or more views of the 3-D model to a convolutional stage of a convolutional neural network;
supply the descriptor to a defect detector to compute one or more defect classifications of the target object; and
output the one or more defect classifications of the target object.

16. The system of claim 15, wherein the memory further stores instructions that, when executed by the processor, cause the processor to control a conveyor system to direct the target object is accordance with the one or more defect classifications of the target object.

17. The system of claim 15, wherein the memory further stores instructions that, when executed by the processor, cause the processor to displaying the one or more defect classifications of the target object on a display device.

18. The system of claim 15, wherein the defect detector comprises a fully connected stage of the convolutional neural network.

19. The system of claim 15, wherein the convolutional neural network is trained based on an inventory comprising:
a plurality of 3-D models of a plurality of defective objects, each 3-D model of the defective objects having a corresponding classification; and
a plurality of 3-D models of a plurality of non-defective objects.

20. The system of claim 19, wherein each of the defective objects and non-defective objects of the inventory is associated with a corresponding descriptor, and
wherein the classifier is configured to compute the classification of the target object by:
outputting the classification associated with a corresponding descriptor of the corresponding descriptors having a closest distance to the descriptor of the target object.

21. The system of claim 15, wherein the one or more views comprise a plurality of views, and
wherein the memory further stores instructions that, when executed by the processor, cause the processor to compute the descriptor by:
supplying each view of the plurality of views to the convolutional stage of the convolutional neural network to generate a plurality of single view descriptors; and
supplying the plurality of single view descriptors to a max pooling stage to generate the descriptor from the maximum values of the single view descriptors.

22. The system of claim 15, wherein the memory further stores instructions that, when executed by the processor, cause the processor to compute the descriptor by:
supplying the one or more views of the 3-D model to a feature detecting convolutional neural network to identify shapes of one or more features of the 3-D model.

23. The system of claim 22, wherein the defect detector is configured to compute at least one of the one or more defect classifications of the target object by:
counting or measuring the shapes of the one or more features of the 3-D model to generate at least one count or at least one measurement;
comparing the at least one count or at least one measurement to a tolerance threshold; and
determining the at least one of the one or more defect classifications as being present in the target object in response to determining that the at least one count or at least one measurement is outside the tolerance threshold.

24. The system of claim 15, wherein the 3-D model comprises a 3-D mesh model computed from the depth images.

25. The system of claim 15, wherein the memory further stores instructions that, when executed by the processor, cause the processor to render the one or more views of the 3-D model by:
rendering multiple views of the entire three-dimensional model from multiple different virtual camera poses relative to the three-dimensional model.

26. The system of claim 15, wherein the memory further stores instructions that, when executed by the processor, cause the processor to render the one or more views of the 3-D model by:
rendering multiple views of a part of the three-dimensional model.

27. The system of claim 15, wherein the memory further stores instructions that, when executed by the processor, cause the processor to render the one or more views of the 3-D model by:
dividing the 3-D model into a plurality of voxels;
identifying a plurality of surface voxels of the 3-D model by identifying voxels that intersect with a surface of the 3-D model;
computing a centroid of each surface voxel; and
computing orthogonal renderings of the normal of the surface of the 3-D model in each of the surface voxels, and
wherein the one or more views of the 3-D model comprises the orthogonal renderings.

28. The system of claim 15, wherein each of the one or more views of the 3-D model comprises a depth channel.
